(19) United States
(12) Patent Application Publication
(10) Pub. No.: US 2018/0024896 A1
(43) Pub. Date: Jan. 25, 2018

(54) INFORMATION PROCESSING SYSTEM, INFORMATION PROCESSING APPARATUS, AND INFORMATION PROCESSING METHOD

(71) Applicant: FUJITSU LIMITED, Kawasaki-shi (JP)

(72) Inventors: SHINJI YAMABIRAKI, Numazu (JP); Keisuke ASAKURA, Numazu (JP)

(73) Assignee: FUJITSU LIMITED, Kawasaki-shi (JP)

(21) Appl. No.: 15/649,195

(22) Filed: Jul. 13, 2017

(30) Foreign Application Priority Data
Jul. 22, 2016 (JP) 2016-144730

(51) Int. Cl. G06F 11/16

(52) U.S. Cl. CPC G06F 11/1658; G06F 2201/805

(57) ABSTRACT

A computer-readable recording medium having stored therein a program for causing a first processor to execute a process, the first processor included in an information-processing system that includes a second processor to store data and receive a data transaction, and a third processor to operate as a stand-by apparatus while the second processor operates as an active apparatus, wherein the process includes generating a temporary-transaction identifier for identifying the transaction; adding the generated temporary-transaction identifier to a first request about the transaction, and transmitting the first request to the second and third processors; and upon receipt of a response to the first request from the second processor, extracting a transaction identifier for identifying the transaction and a data identifier for identifying the data from the response, adding the transaction and data identifiers to a second request about the transaction, and transmitting the second request to the second and third processors.

### CROSS-REFERENCE TO RELATED APPLICATION

This application is based upon and claims the benefit of priority of the prior Japanese Patent Application No. 2016-144730, filed on Jul. 22, 2016, the entire contents of which are incorporated herein by reference.

### FIELD

The embodiments discussed herein are related to an information processing system, an information processing apparatus, and an information processing method.

### BACKGROUND

In services whose failures and interruptions are unacceptable, such as bank online systems and electronic commerce transactions, making redundant data in a plurality of hardware apparatuses enables continuous processing of jobs without generation of data loss even if one of the hardware apparatuses is broken down. For such redundant data, however, consistency of the data has to be ensured among these hardware apparatuses. To satisfy this consistency, mirroring of the data from an active apparatus to a stand-by apparatus is performed.

FIG. 39 is a diagram illustrating mirroring in related techniques. In FIG. 39, a server #901 operates as an active server to store data used by an application which operates in a client #9. A server #902 operates as a stand-by server which functions as a substitute of the active server if the active server has a failure.

The server #901 performs a series of data manipulations in a single transaction. When the commit processing for the transaction is completed, the server #901 transmits the information on the series of data manipulations to the server #902 for mirroring. Herein, the data manipulation refers to addition, deletion, or update of data. The consistency of the data between the server #901 and the server #902 is ensured by performing such mirroring of the data. The mirroring ensures the consistency of data between a server and another server.

Related techniques include a technique of establishing a manipulation command in one phase, wherein a first DB server executes the manipulation command transmitted from an application server; when an established command is transmitted, the result of execution is reflected in the first DB server, and the result of execution by the first DB server is transmitted to a second DB server. There is a technique for performing high-speed alternation processing through transmission of an alternation packet which requests the alternation of a master database server to a replicated database server or vice versa, and transmission of packets for synchronization of the alternation processing using multicast communication in which a group of database servers is defined as a multicast group.

The related techniques are disclosed, for example, in Japanese Laid-open Patent Publication Nos. 2012-155499 and 2003-186722.

The mirroring illustrated in FIG. 39 has a reduced transaction performance because the mirroring takes a lot of time. For example, if 100 pieces of added data are processed in the server #901 and each piece of the data is 1 MB (megabyte), the communication of 100 MB of the data occurs due to the mirroring, reducing the transaction performance.

In particular, in cloud computing, data requests to be made redundant among availability zones in which physical server racks, networks, power supply facilities, and the like are separated. The communication of the redundant data among the availability zones via routers takes a lot of time.

### SUMMARY

According to an aspect of the embodiments, an information processing system includes: a first processor configured to operate an application; a second processor configured to receive a transaction with respect to the data from the first processor; and a third processor configured to operate as a stand-by processor while the second processor operates as an active processor, wherein the first processor generates a temporary transaction identifier for identifying the transaction, adds the generated temporary transaction identifier to a first request about the transaction, and transmits the first request to the second processor and the third processor, when the second processor receives the first request, the second processor determines a transaction identifier for identifying the transaction, determines a data identifier for identifying data to be processed by the first request, adds the transaction identifier and the data identifier to a response to the first request, and transmits the response to the first processor, when the first processor receives the response, the first processor adds the transaction identifier and the data identifier contained in the response to a second request about the transaction, and transmits the second request to the second processor and the third processor, and the third processor manages transaction information for associating the temporary transaction identifier contained in the first request with the transaction identifier and the data identifier contained in the second request, and upon receipt of a commit request about the transaction from the first processor, the third processor performs commit processing on the transaction based on the transaction information.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1A is a first diagram illustrating a flow of the processing of an information processing system according to an embodiment;

FIG. 1B is a second diagram illustrating the flow of the processing of the information processing system according to the embodiment;

FIG. 1C is a third diagram illustrating the flow of the processing of the information processing system according to the embodiment;

FIG. 2 is a diagram illustrating an example of a structure of a temporary transaction ID;

FIG. 3 is a diagram illustrating the timings at which a client apparatus and a stand-by server obtain transaction IDs and data IDs;

FIG. 4 is a diagram illustrating a flow of processing when a manipulation message is lost in an active server;

FIG. 5A is a first diagram illustrating a flow of processing when a manipulation message is lost in a stand-by server;

FIG. 5B is a second diagram illustrating the flow of the processing when the manipulation message is lost in the stand-by server;

FIG. 6 is a diagram illustrating a flow of processing when a message for committing is lost in a stand-by server;

FIG. 7A is a first diagram illustrating a flow of processing when an overtaking of a message occurs due to a delayed communication;

FIG. 7B is a second diagram illustrating the flow of the processing when the overtaking of a message occurs due to a delayed communication;

FIG. 7C is a third diagram illustrating the flow of the processing when the overtaking of a message occurs due to a delayed communication;

FIG. 8 is a diagram illustrating a configuration of an information processing system according to an embodiment;

FIG. 9 is a diagram illustrating an example of a configuration of hardware of a server apparatus;

FIG. 10 is a diagram illustrating an example of a configuration of hardware of a client apparatus;

FIG. 11 is a diagram illustrating functional configurations of a server apparatus and a client apparatus;

FIG. 12 is a diagram illustrating an example of a data memory;

FIG. 13 is a diagram illustrating an example of a transaction information memory;

FIG. 14A is a diagram illustrating of an example of a stand-by response memory (where one stand-by server is present);

FIG. 14B is a diagram illustrating an example of a stand-by response memory (where two stand-by servers are present);

FIG. 15 is a diagram illustrating an example of a data ID memory;

FIG. 16 is a diagram illustrating an example of a temporary transaction ID;

FIG. 17 is a diagram illustrating an example of a request message (data manipulation);

FIG. 18 is a diagram illustrating an example of a response message (data manipulation);

FIG. 19 is a diagram illustrating an example of a request message (commit);

FIG. 20 is a diagram illustrating an example of a response message (commit);

FIG. 21A is a first diagram illustrating an entire flow;

FIG. 21B is a second diagram illustrating the entire flow;

FIG. 21C is a third diagram illustrating the entire flow;

FIG. 22 is a flowchart illustrating a flow of first data manipulation processing (phase #1) by a client #1;

FIG. 23 is a flowchart illustrating a flow of first data manipulation processing (phase #1) by an active server;

FIG. 24 is a flowchart illustrating a flow of first data manipulation processing (phase #1) by a stand-by server;

FIG. 25 is a flowchart illustrating a flow of second and subsequent data manipulation processings (phase #2) by the client #1;

FIG. 26 is a flowchart illustrating a flow of second and subsequent data manipulation processings (phase #2) by the active server;

FIG. 27 is a flowchart illustrating a flow of second and subsequent data manipulation processings (phase #2) by the stand-by server;

FIG. 28 is a flowchart illustrating a flow of commit processing (phase #3) by the client #1;

FIG. 29 is a flowchart illustrating a flow of commit processing (phase #3) by the active server;

FIG. 30 is a flowchart illustrating a flow of commit processing (phase #3) by the stand-by server;

FIG. 31 is a diagram illustrating a flow when the active server does not respond to the data manipulation request;

FIG. 32 is a diagram illustrating a flow when the stand-by server does not respond to the data manipulation request;

FIG. 33 a diagram illustrating a flow when the active server does not respond to the commit request;

FIG. 34 is a diagram illustrating a flow when the stand-by server does not respond to the commit request;

FIG. 35 is a diagram illustrating a flow when the stand-by server does not respond to the commit operation request and the data of interest is operated with another application during rewriting of the data;

FIG. 36 is a flowchart illustrating a flow of processing by the client #2 to check a precedent transaction;

FIG. 37 is a flowchart illustrating a flow of processing by the active server to receive the data manipulation request from the client #2 and check the precedent transaction;

FIG. 38 is a flowchart illustrating a flow of processing by the stand-by server to receive the data manipulation request from the client #2 and check the precedent transaction; and

FIG. 39 is a diagram illustrating mirroring in a related art.

### DESCRIPTION OF EMBODIMENTS

Embodiments of an information processing system, an information processing apparatus, an information processing method, and a program disclosed herein will now be described in detail with reference to the drawings. These embodiments are not intended to limit the techniques disclosed herein.

### Embodiments

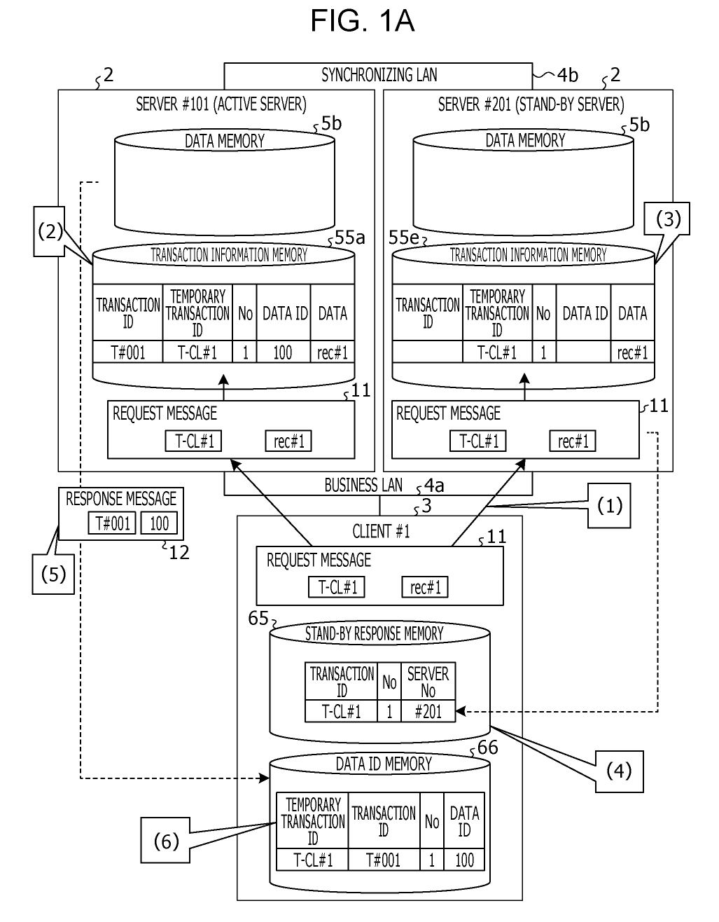

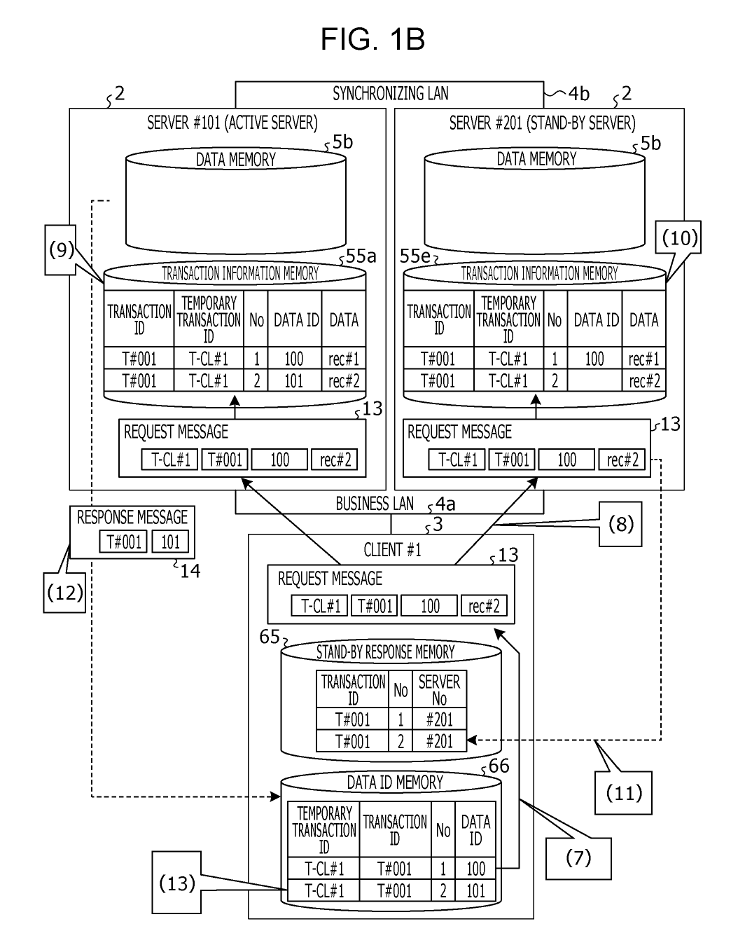

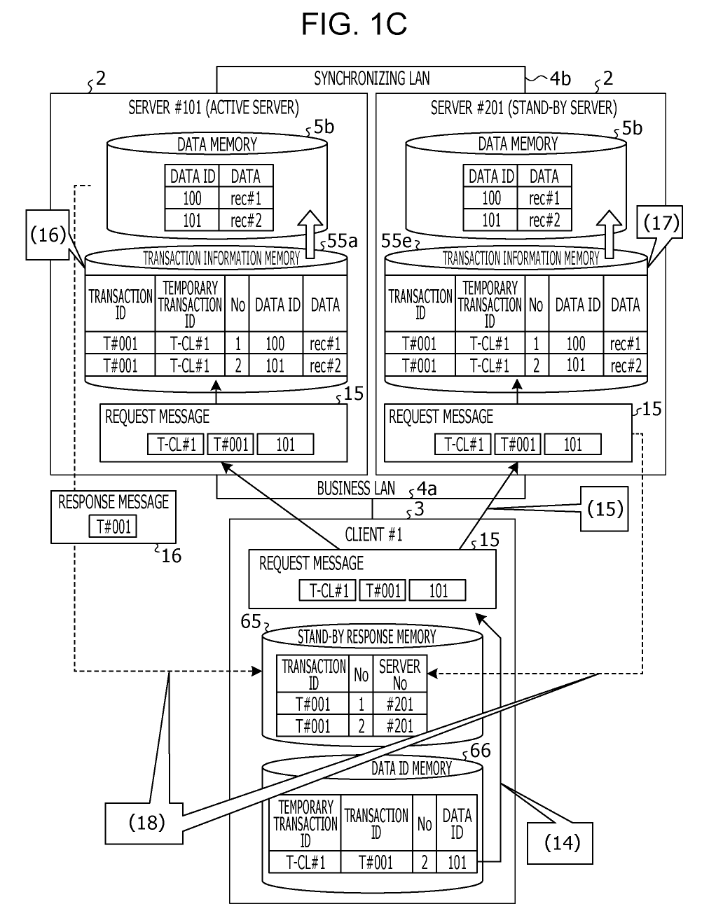

The flow of processing of an information processing system according to an embodiment will be described. FIGS. 1A to 1C are first to third diagrams illustrating the flow of the processing of the information processing system according to the embodiment. FIG. 1A illustrates addition of data, FIG. 1B illustrates update of data, and FIG. 1C illustrates committing of data. In FIG. 1A, a server #101 and a server #201 are server apparatuses 2. The server apparatus 2 stores the data used by an application operating in a client #1, and performs transaction processing in response to the reception of a transaction request from the client #1. The server #101 operates as an active server, and the server #201 operates as a stand-by server.

The client #1 is a client apparatus 3 on which an application using the data stored in the server apparatus 2 operates. The client #1, the server #101, and the server #201 are connected to each other through a business local area network (LAN) 4a. The server #101 and the server #201 are connected through a synchronizing LAN 4b.

As illustrated in FIG. 1A, the client #1 transmits a request message 11 to add data to the servers #101 and #201. During the transmission of the message at the beginning of the transaction, the client #1 generates a temporary transaction ID “T-CL#1”, and adds the ID to the message (1). The temporary transaction ID is a temporary identifier to identify a transaction. The request message 11 contains the temporary transaction ID “T-CL#1” and the data “rec#1” to be added.

The client #1 stores and manages the temporary transaction ID as a transaction ID in a stand-by response memory 65. After the active server determines the permanent identifier for the transaction, the transaction ID in the stand-by response memory 65 is replaced by the permanent identifier. The “No.” in the stand-by response memory 65 refers to the serial number of the data manipulation. The client #1 stores and manages the temporary transaction ID in the data ID memory 66.

In response to the reception of the request message 11, the active server performs transaction processing. After performing the transaction processing, the active server determines the transaction ID and the data ID (2). Herein, the transaction ID is an identifier for identifying the transaction, and the data ID is an identifier for identifying the data. The active server stores and manages the transaction ID, the temporary transaction ID, the serial number No, the data ID, and the data in a transaction information memory 55a. In FIG. 1A, a transaction ID “T#001”, a temporary transaction ID “T-CL#1”, a serial number “1”, a data ID “100”, and data “rec#1” are managed using the transaction information memory 55a.

In contrast, in response to the reception of the request message 11, the stand-by server manages the data “rec#1” using the temporary transaction ID (3). The stand-by server stores and manages the temporary transaction ID, the serial number No, and the data in the transaction information memory 55e. The transaction ID and the data ID at this timing are empty. The stand-by server updates the transaction information memory 55e including the transaction ID and the data ID during the reception of the next message. The stand-by server then responds to the client #1. If the stand-by server responds, the client #1 adds the identification number of the stand-by server to the server No. of the stand-by response memory 65 (4). In FIG. 1A, the server No “#201” is added.

The active server embeds the data ID of the processed data and the transaction ID of the processed transaction in a response message 12, and returns the message (5). In FIG. 1A, the response message 12 contains the transaction ID “T#001” and the data ID “100”. In response to the reception of the response message 12, the client #1 stores the data ID “100” of the target data for the processing and the transaction ID “T#001” in a data ID memory 66 (6). The client #1 also overwrites the transaction ID in the stand-by response memory 65 with the transaction ID “T#001” contained in the response message 12.

As illustrated in FIG. 1B, during the transmission of a subsequent request message 13 to update the data, the client #1 assigns the transaction ID and the data ID to the request message 13 with reference to the data ID memory 66 (7). The client #1 then transmits the request message 13 to update the data to the server #101 and the server #201 (8). The client #1 simultaneously transmits the temporary transaction ID and the data to be updated as well as the permanent transaction ID and the data ID of the previous data. In FIG. 1B, the request message 13 contains the temporary transaction ID “T-CL#1”, the data “rec#2” to be updated, and the transaction ID “T#001” and the data ID “100” stored in the data ID memory 66.

In response to the reception of the request message 13, the active server performs transaction processing. After performing the transaction processing, the active server determines the data ID of the target data for the processing (9). The active server then stores the transaction ID, the temporary transaction ID, the serial number No, the data ID, and the data in the transaction information memory 55a. In FIG. 1B, the transaction ID “T#001”, the temporary transaction ID “T-CL#1”, the serial number No “2”, the data ID “101”, and the data “rec#2” are stored in the transaction information memory 55a.

In response to the reception of the request message 13, the stand-by server updates the data ID of the data “rec#1” previously manipulated and the transaction ID in correspondence of the temporary transaction ID “T-CL#1” with the permanent transaction ID “T#001” in a transaction information memory 55e (10). The stand-by server then responds to the client #1. If the stand-by server responds, the client #1 adds the identification number of the stand-by server to the server No in the stand-by response memory 65. In FIG. 1B, the server No “#201” is added. The client #1 deletes the information on the data ID having the serial number No “1” from the data ID memory 66 (11). In FIG. 1B, the information on the data ID “100” is deleted.

The active server embeds the data ID and the transaction ID of the transaction in a response message 14, and returns the response message 14 (12). In FIG. 1B, the response message 14 contains the transaction ID “T#001” and the data ID “101”. In response to the reception of the response message 14, the client #1 stores the data ID “101” and the transaction ID “T#001” in the data ID memory 66 (13).

As illustrated in FIG. 1C, during the transmission of a subsequent request message 15 for committing, the client #1 assigns the transaction ID and the data ID to the request message 15 with reference to the data ID memory 66 (14). The client #1 then transmits the commit request message 15 to the server #101 and the server #201 (15). Namely, the client #1 simultaneously transmits the temporary transaction ID, the transaction ID, and the data ID of the previous data. In FIG. 1C, the request message 15 contains the temporary transaction ID “T-CL#1”, and the transaction ID “T#001” and the data ID “101” stored in the data ID memory 66.

In response to the reception of the request message 15, the active server performs commit processing (16). Namely, the active server reflects the information in the transaction information memory 55a to the data memory 5b. At this time, the active server retains the information stored in the transaction information memory 55a, rather than deletes the information.

In response to the reception of the request message 15, the stand-by server performs the commit processing based on the request message 15 and the information in the transaction information memory 55e (17). Namely, the stand-by server reflects the request message 15 and the information in the transaction information memory 55e to the data memory 5b. At this time, the stand-by server retains the information stored in the transaction information memory 55e, rather than deletes the information.

In (16) and (17), the active server and the stand-by server retain the information in the transaction information memories 55a and 55e, respectively, without deleting it, until the client #1 transmits a request next time. Namely, when the client #1 transmits the request next time, the information in the transaction information memories 55a and 55e is deleted.

The client #1 waits for the responses from both of the server #101 and the server #201 (18). A response message 16 from the server #101 contains a transaction ID. In FIG. 1C, the response message 16 contains the transaction ID “T#001”.

The order to execute the transaction is important in the case where the server apparatus 2 simultaneously processes requests from two or more client apparatuses 3 by multithreading. For example, the results of update of the same data may be different between the case where the client #1 operates first and the case where the client #2 operates first. In the present embodiment, the consistency of the transactions in all of the server apparatuses 2 including the redundant configuration is guaranteed by only the active server determining the order to execute the transaction and the stand-by server managing the data based on the transaction IDs assigned by the active server.

The data to be processed in the transaction has to be uniquely specified by the active server. For example, it is also possible to specify the data uniquely by the stand-by server in the followings cases:

a uniqueness constraint (such as a main key) is preliminarily defined, such as relational database (RDB); and

the key value corresponding to the data is preliminarily known, such as a Key-Value method.

However, since the client apparatus 3 has no information to preliminarily specify the data in the cases where the Key-Value method is not used or the uniqueness constraint is not defined, the target data for the processing is not uniquely specified by the active server and the stand-by server. In the case where the transactions of the data manipulations are simultaneously executed by a plurality of client apparatuses 3, the “data” is allowed to be uniquely determined only after the order to execute the transactions is determined.

In the present embodiment, similarly to the transaction ID, only the active server determines the “data ID”, which is the information to uniquely specify the data, and the stand-by server manages the data based on the data ID assigned by the active server. Accordingly, the consistency of the transaction in the configuration including the redundant configuration is guaranteed. The data ID is newly assigned in addition of the data, while the data ID of the target data for update is used in update of the data.

To guarantee the consistency of the transaction in all of the server apparatuses 2 including the redundant configuration, the order to execute the transaction and the data manipulated in the transaction have to be matched in the information processing system. However, the order to execute the transaction, the transaction ID to uniquely specify the transaction, and the data ID to uniquely specify the target data for the processing are assigned or specified only by the active server. For this reason, the order to execute the transaction and the data manipulated in the transaction are not matched in the information processing system by a conventional method. In the present embodiment, the consistency of the transaction is guaranteed through assignment of the “temporary transaction ID” by the client apparatus 3 and management of the transaction information of the active server and the stand-by server based on the “temporary transaction ID”.

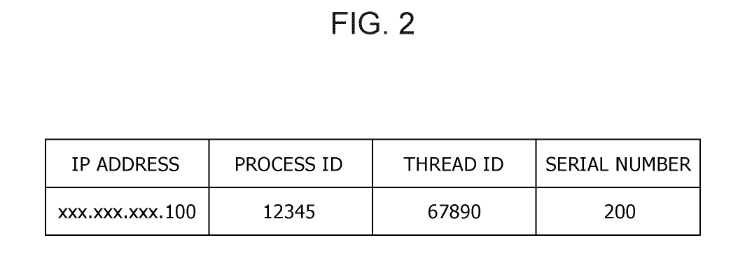

FIG. 2 is a diagram illustrating an example of a structure of a temporary transaction ID. As illustrated in FIG. 2, the temporary transaction ID contains an IP address, a process ID, and a thread ID. The IP address is the IP address of the client apparatus 3. The process ID and the thread ID are identifiers of the process and the thread of an application transmitting a request message. The serial number is a serial number within the process.

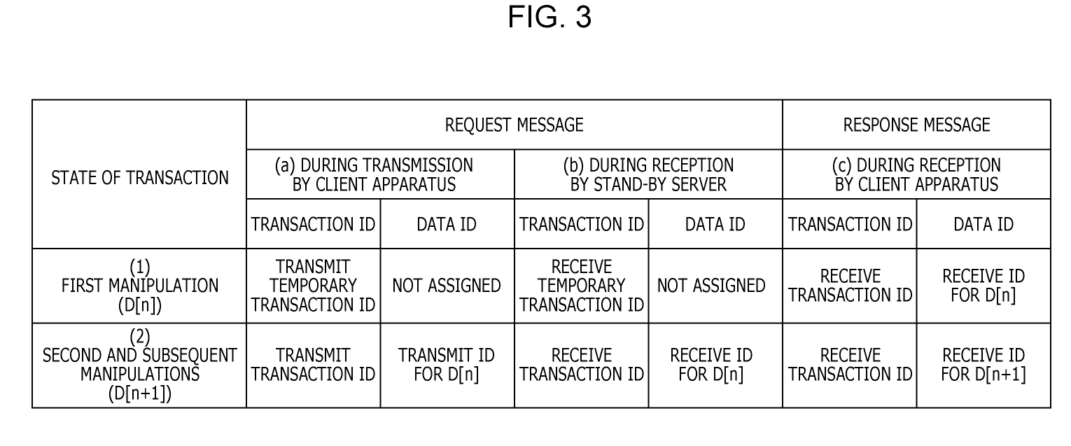

FIG. 3 is a diagram illustrating the timing at which the client apparatus 3 and the stand-by server obtains the transaction IDs and the data IDs. In FIG. 3, D[n] represents the data manipulated in the n-th order. Since the client apparatus 3 does not preliminarily obtain the transaction ID in the first processing of a transaction, the client apparatus 3 generates a temporary transaction ID, and transmits the temporary transaction ID to the stand-by server (1a in FIG. 3). The stand-by server, which receives the request message, manages the data using the temporary transaction ID (1b in FIG. 3). At this time, the transaction ID and the data ID are not specified in the stand-by server.

The active server adds the permanent transaction ID and the data ID to the response message, and notifies the client apparatus 3 of the permanent transaction ID and the data ID. The notified transaction ID and data ID are recorded in the data ID memory 66 in the client apparatus 3 (1c in FIG. 3). During the next transmission of the request message, the client apparatus 3 reads the data ID of the data previously processed and the transaction ID from the data ID memory 66, adds the data ID and the transaction ID to a request message, and transmits the request message (2a in FIG. 3).

Namely, in the embodiment, the client apparatus 3 transmits the transaction ID and the data ID assigned by the active server to the stand-by server in the request message for the next processing, thereby matching the transaction ID and the data ID in the information processing system (the notification of the information is delayed by one processing in the stand-by server). Since the client apparatus 3 is allowed to obtain the transaction ID once the transaction is started, the stand-by server is also allowed to obtain the transaction ID during the reception of the request message in the second and subsequent transaction processings (2b in FIG. 3).

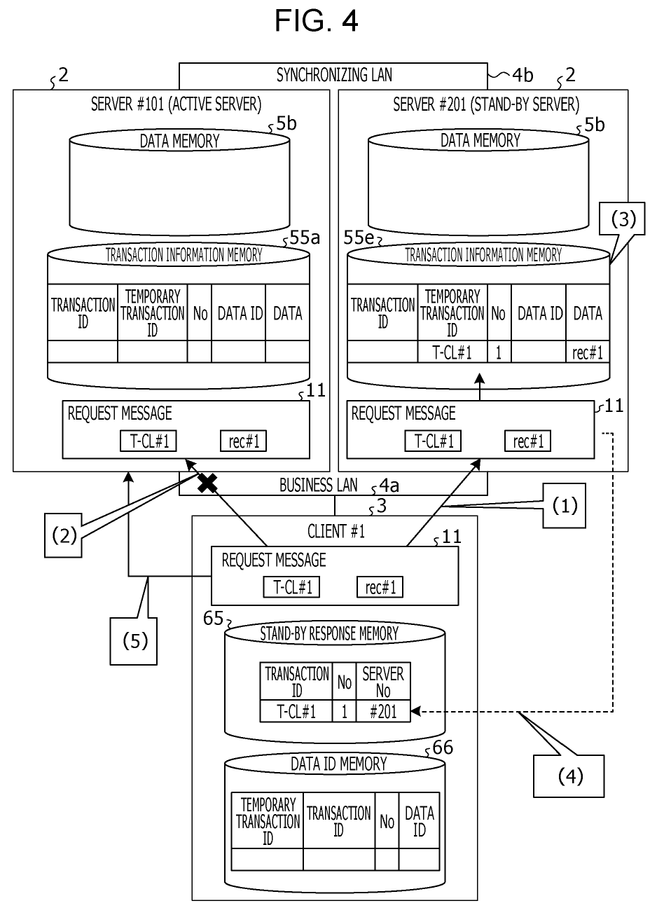

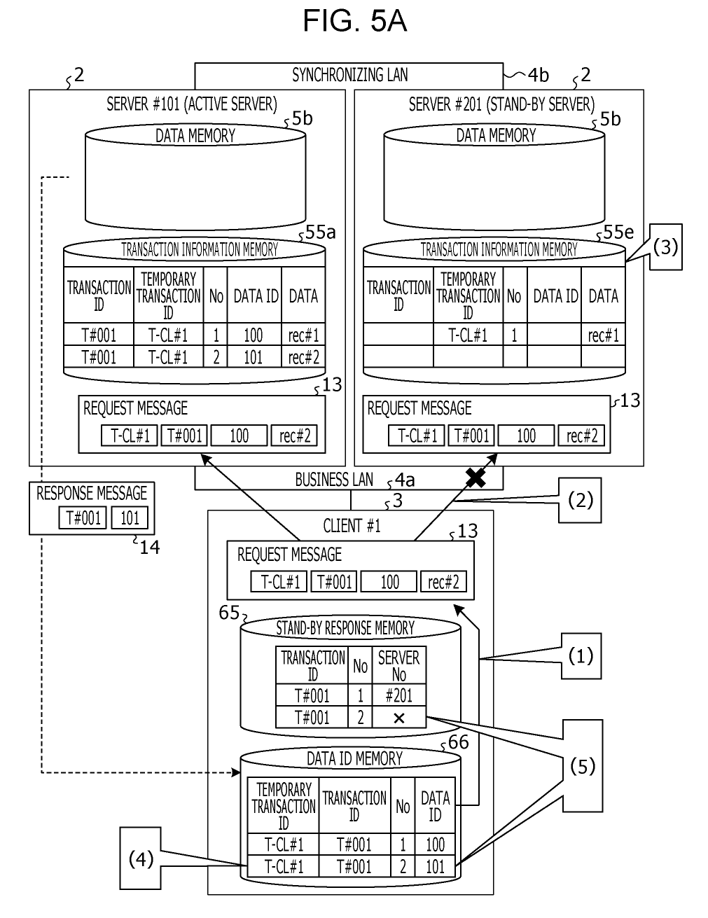

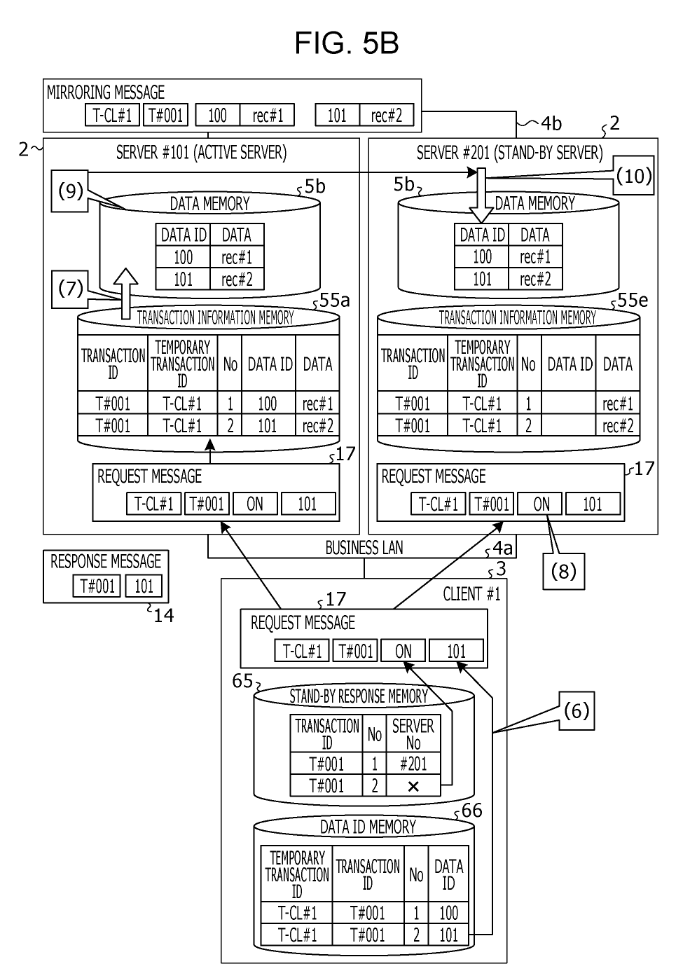

The flow of processing when the manipulation message is lost will now be described using FIGS. 4 to 5B. FIG. 4 is a diagram illustrating a flow of processing when a manipulation message is lost in the active server. In the present embodiment, since only the active server performs the transaction processing (such as assignment of a variety of IDs and exclusive control), the loss of the manipulation message to the active server causes the state where the active server does not respond. The client apparatus 3 waits for the response from the active server for a predetermined time. If the active server does not respond after the predetermined time has passes, the client apparatus 3 retransmits the manipulation message to the active server. If the active server still does not respond after the client apparatus 3 has retransmitted the manipulation message predetermined times, the client apparatus 3 determines that there is a permanent abnormality in communication, performs a rollback (clears the transaction information accumulated in the stand-by server), and notifies the application of an error.

Namely, as illustrated in FIG. 4, the client #1 transmits the request message 11 for addition of the data to the servers #101 and #201 (1). The message is lost on the way to the active server (2). In response to the reception of the request message 11, the stand-by server manages the data “rec#1” using the temporary transaction ID (3). At this timing, the transaction ID and the data ID are empty, and are updated during the next reception of the request message. The stand-by server then responds to the client #1. If the stand-by server responds, the client #1 adds the identification number of the stand-by server to the server No in the stand-by response memory 65 (4).

The client #1 waits for the response from the active server. If the active server does not respond for a predetermined time, the client #1 retransmits the request message 11 (5). If the active server still does not respond after the client #1 has retransmitted the request message predetermined times, the client #1 rolls back the processing to recover from an error.

FIGS. 5A and 5B are first and second diagrams illustrating a flow of processing when the manipulation message is lost in the stand-by server. In the present embodiment, for an enhanced response of the transaction processing, the following methods are used to wait for the response:

request message for committing: the responses from the active server and the stand-by server are waited by a synchronizing method; and

request message for addition, update, or deletion: the response from the active server is waited by a synchronizing method and the response from the stand-by server is waited by a non-synchronizing method.

If the response to the request message for addition, update, or deletion from the stand-by server is not confirmed during execution of committing, the client apparatus 3 determines that the message to the stand-by server is lost, and switches the method to mirroring of the data from the active server to the stand-by server during transmission of the commit request.

For example, as illustrated in FIG. 5A, the client #1 assigns the transaction ID and the data ID to the request message 13 to update the data (1). The client #1 then transmits the request message 13 for update of the data to the server #101 and the server #201 (2).

Since the packet of the request message to the stand-by server is lost, the stand-by server is not allowed to update the data ID of the data “rec#1” (3). In contrast, the active server transmits the response message 14, and the client #1 stores the data ID and the transaction ID, which are contained in the response message 14 from the active server, in the data ID memory 66 (4). Unfortunately, since the transmission of the request message to the stand-by server is failed, the client #1 is not allowed to receive the response from the stand-by server. Accordingly, the client #1 is not allowed to overwrite the information to the server No in the stand-by response memory 65, and the processing is not completed. In addition, since the transmission of the transaction ID and the data ID is not allowed to be confirmed, the information of the serial number No “1” in the data ID memory 66 is not deleted (5).

As illustrated in FIG. 5B, since the stand-by response memory 65 indicates that the processing performed by the stand-by server on the transaction having the transaction ID “T#001” is not completed, the client #1 sets a mirroring commit flag to “ON”, and transmits a commit request message 17 (6). If one or more entries not responded are recorded in the stand-by response memory 65 at the time of committing, the client #1 switches the method to the mirroring method.

In response to the reception of the request message 17, the active server executes commit processing (7). When the stand-by server receives the request message 17, the stand-by server waits for the instruction from the active server because the mirroring commit flag is “ON” (8). The active server then mirrors the target data for committing since the mirroring commit flag is “ON” (9). The stand-by server then performs the committing by the mirroring (10).

A flow of processing when the message for committing is lost will now be described. If the active server and the stand-by server simultaneously transmit request messages for commit processing and perform the commit processing in parallel, part of the servers may successfully perform the commit processing and part of the servers may unsuccessfully perform the commit processing, causing inconsistency of the data between the servers. This inconsistency of the data between the servers leads to the inconsistency of the transaction when another client apparatus 3 requests the manipulation of the same data.

In the present embodiment, to avoid such inconsistency, the information processing system performs the following processing. Herein, a client apparatus 3 which retransmits the message for committing for a transaction of data is defined as a client #1, and another client apparatus 3 which performs a transaction on the data while the client #1 is retransmitting the message for committing is defined as a client #2.

The client #1 retransmits the request message when the commit request message is lost. When the commit request message to the active server is lost, during the requesting of the manipulation from the client #2, the active server detects from the information of the transaction information memory 55a that the client #1 is performing a transaction on the data, and causes the client #2 to retry. When the commit request message to the stand-by server is lost, the active server retains the information in the transaction information memory 55a even after the transaction processing for the client #1 is completed. At the start of the following transaction processing for the client #2, the active server and the stand-by server each detect from the transaction IDs and the temporary transaction IDs stored in the transaction information memories 55a and 55e that the data is being committed. The active server and the stand-by server then transmit the information of the precedent transaction so as to cause the client #2 to retry.

If the commit request message to the active server is lost, the active server and the stand-by server each have the following states:

Active server: Committing is failed. A transaction is being performed. The data has been locked (excluded). Stand-by server: Committing is successfully performed. A transaction is committed.

In this case, even if the following client #2 transmits a request message for update of the data while the precedent client #1 is retransmitting the request for committing of the same data to the active server, the active server has already locked the data for the client #1. For this reason, when the request message to update the data from the client #2 arrives, the active server is allowed to cancel (roll back) the manipulation to update the data by the client #2.

If the commit request message to the stand-by server is lost, the active server and the stand-by server each have the following states:

Active server: Committing is successfully performed. A transaction is committed. Stand-by server: Committing is failed. A transaction is being performed. The transaction ID and the data ID are not specified.

The active server retains the information in the transaction information memory 55a even after the transaction processing for the client #1 is completed. At the start of the following transaction processing for the client #2, the active server notifies the client #2 of the transaction ID and the temporary transaction ID of the same data (the same data ID) as the data retained in the transaction information memory 55a.

On the other hand, from the comparison of the data (such as strings of letters, and binary comparison) and the comparison of index key values, the stand-by server predicts that there is a client #1 which is committing the “data which is presumed to be the same data (the identity is not confirmed because the data ID is not specified)” as the data to be manipulated by the client #2. The stand-by server then notifies the client #2 of the transaction ID and the temporary transaction ID of the predicted precedent transaction.

The client #2 associates the information of the precedent transaction predicted by the stand-by server with the information of the precedent transaction obtained from the response of the active server using the temporary transaction ID, and detects that the transaction of the same data is being committed.

Although an index is often used to specify the data to be manipulated (updated, added, or deleted), the index has no uniqueness constraint in some cases. For this reason, the stand-by server is allowed to only predict the precedent transaction even if performing the comparison of the index key values. The client #2 is allowed to determine the presence or absence of the precedent transaction only by checking the response from the active server against the response from the stand-by server.

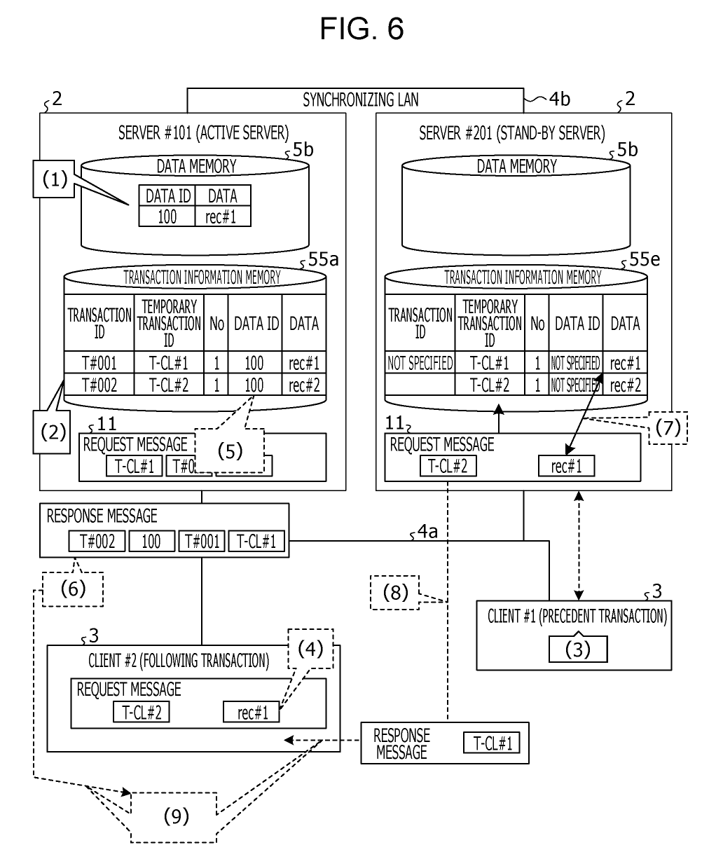

FIG. 6 is a diagram illustrating a flow of processing when the message for committing is lost in the stand-by server. As illustrated in FIG. 6, the commit processing of the transaction ID “T#001” is successfully performed in the active server (1). The stand-by server then retains the information stored in the transaction information memory 55a until the client #1 transmits the next request, namely, until the commit processing by the stand-by the server is completed in the client #1 (2).

At this time, since the message for committing having the transaction ID “T#001” to the stand-by server is lost, the client #1 is being retransmitting the message for committing to the stand-by server (3). The client #2 requests processing to update the data ID “100” (temporary transaction ID: “T-CL#2” (4).

The active server then executes the processing of the transaction (temporary transaction ID: “T-CL#2”) requested by the client #2. In addition, the active server detects that the data having the same data ID “100” as that of the data “rec#1” to be processed is already being processed as the transaction ID “T#001” (T-CL#1) (5). The active server simultaneously transmits, to the client #2, the response about the transaction ID “T#002” and the temporary transaction ID “T-CL#2” and the response about the precedent transaction having the transaction ID “T#001” and the temporary transaction ID “T-CL#1” (6).

On the other hand, the stand-by server performs comparison using the data to be processed (temporary transaction ID “T-CL#2” from the client #2) or the index key value, and detects that the data which is presumed to be the same data as the data having the temporary transaction ID “T-CL#2” is being processed as the precedent transaction (T-CL#1) (7). The stand-by server then transmits a response including the information of the transaction (T-CL#2) from the client #2 and the information of the precedent transaction (T-CL#1) (8).

When receiving the responses from the active server and from the stand-by server, the client #2 detects that the precedent transaction (T-CL#1) to manipulate the same data is present in the stand-by server. The client #2 then rolls back the transaction (T#002, T-CL#2), and causes the application to retry (9). Herein, “App” refers to an application.

A flow of processing when overtaking of a message occurs due to delayed communication will now be described. In the information processing system according to the embodiment, the active server starts the transaction in the order of arrival of the request message for the processing. If the same data is manipulated, the following transaction waits for the completion of the precedent transaction, or the client apparatus 3 transmits an error notification to the application. On the other hand, the stand-by server waits for the response message by the non-synchronizing method. Considering a standard network environment which does not guarantee overtaking of a message, the stand-by server may receive the request message in an order different from the order of arrival of the request message in the active server.

In the information processing system according to the embodiment, only the active server performs the transaction processing, and notifies the stand-by server of the information (transaction ID and data ID) in the active server through the client apparatus 3. For this reason, the consistency of the data between the active server and the stand-by server is maintained even if the stand-by server may receive the request message in an order different from the order of arrival of the request message in the active server.

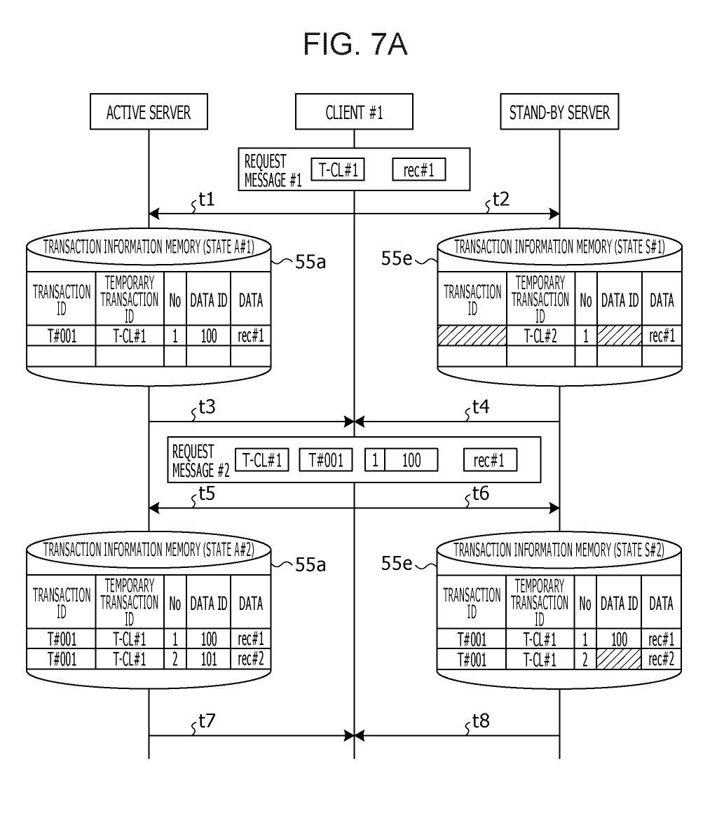

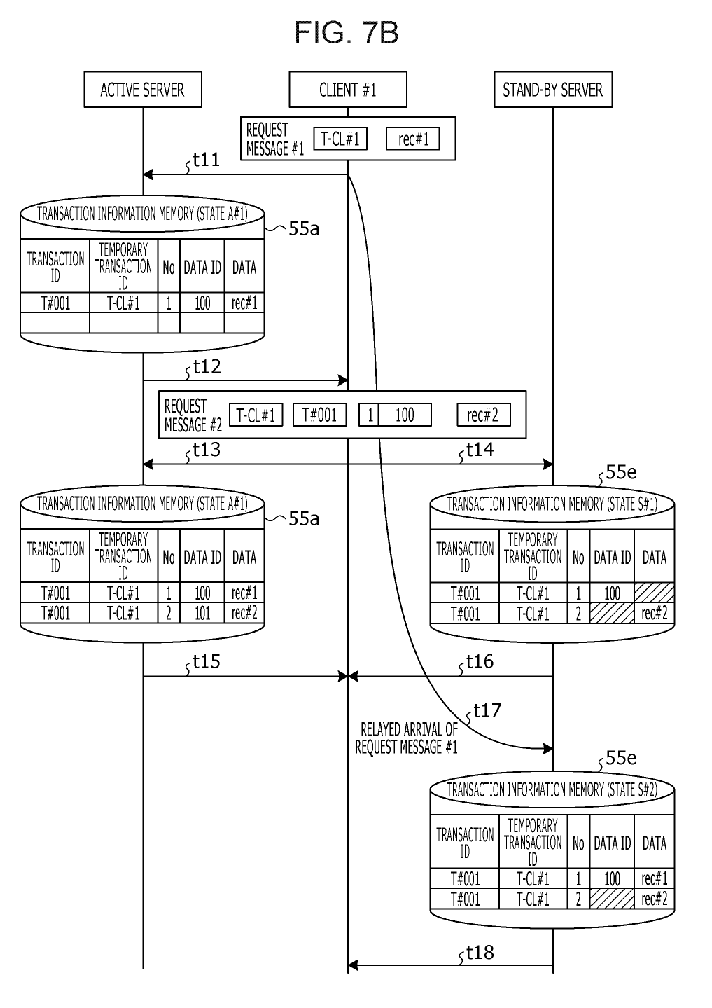

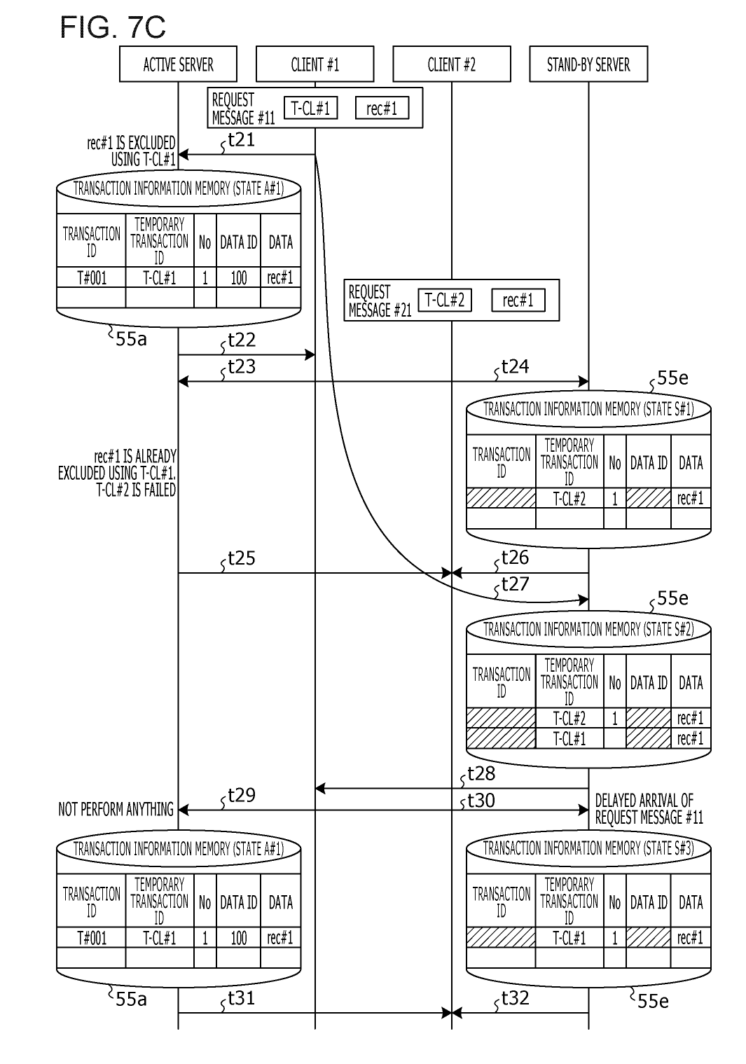

FIGS. 7A to 7C are first to third diagrams illustrating a flow of processing when overtaking of a message occurs due to delayed communication. FIG. 7A illustrates a normal case where no overtaking of a message occurs. FIG. 7B illustrates the case where the order of arrival of the message is different between the active server and the stand-by server. FIG. 7C illustrates the case where the orders of arrival of the messages from multiple clients are different between the active server and the stand-by server.

As illustrated in FIG. 7A, in the normal case, the active server receives a request message #1 from the client #1 (t1). The stand-by server receives the request message #1 from the client #1 (t2). The active server then updates the transaction information memory 55a, and responds to the client #1 (t3). The stand-by server updates the transaction information memory 55e, and responds to the client #1 (t4).

The active server then receives a request message #2 from the client #1 (t5). The stand-by server receives the request message #2 from the client #1 (t6). The active server then updates the transaction information memory 55a, and responds to the client #1 (t7). The stand-by server updates the transaction information memory 55e, and responds to the client #1 (t8).

In contrast, in FIG. 7B, the active server receives the request message #1 and the request message #2 in this order. The stand-by server receives the request message #2 and the request message #1 in this order. Such overtaking of the message barely occurs in an on-premise environment, but has to be considered in cloud environments using network environments via a plurality of network apparatuses, in which the quality of communication is not guaranteed (inexpensive low-speed network apparatuses and the Internet environment).

As illustrated in FIG. 7B, the active server receives the request message #1 from the client #1 (t11), updates the transaction information memory 55a, and responds to the client #1 (t12). The active server then receives the request message #2 from the client #1 (t13). The stand-by server receives the request message #2 from the client #1 (t14).

The active server then updates the transaction information memory 55a, and responds to the client #1 (t15). The stand-by server updates the transaction information memory 55e, and responds to the client #1 (t16). The stand-by server then receives the delayed request message #1 (t17), updates the transaction information memory 55e, and responds to the client #1 (t18). The state of the transaction information memory 55e in the stand-by server at this time is compared to the state illustrated in FIG. 7A. The state of the transaction information memory 55e is the same as the state S#2.

In FIG. 7C, even if the order of arrival of the request message transmitted from a different client apparatus 3 is different between the active server and the stand-by server, the request message is processed according to the order of arrival in the active server. If the request message is a request to manipulate the same data, the request message previously arrived in the active server has precedence, and the processing of the transaction is started. In the client apparatus 3 from which the request message arrives in the active server afterward, the exclusion of the data is failed. For this reason, the transaction (temporary transaction ID: “T-CL#2”) previously arrived in the stand-by server is rolled back (or retried).

As illustrated in FIG. 7C, the active server receives the request message #11 from the client #1 (t21), updates the transaction information memory 55a, and responds to the client #1 (t22). The active server then receives the request message #21 from the client #2 (t23). Since rec#1 is already excluded using T-CL#1, the active server responds to the client #2 about the failure (t25) of T-CL#2.

On the other hand, the stand-by server receives the request message #21 from the client #2 (t24), updates the transaction information memory 55e, and responds to the client #2 (t26). The stand-by server then receives the delayed request message #11 (t27), updates the transaction information memory 55e, and responds to the client #1 (t28).

When the client #2 receives the notification of the failure of T-CL#2, the client #2 instructs the active server and the stand-by server to roll back T-CL#2 (t29, t30). While the active server having received the instruction does not perform anything, the stand-by server having received the instruction clears the information of T-CL#2 in the transaction information memory 55e by rolling back. The active server and the stand-by server then respond to the client #2 (t31, t32).

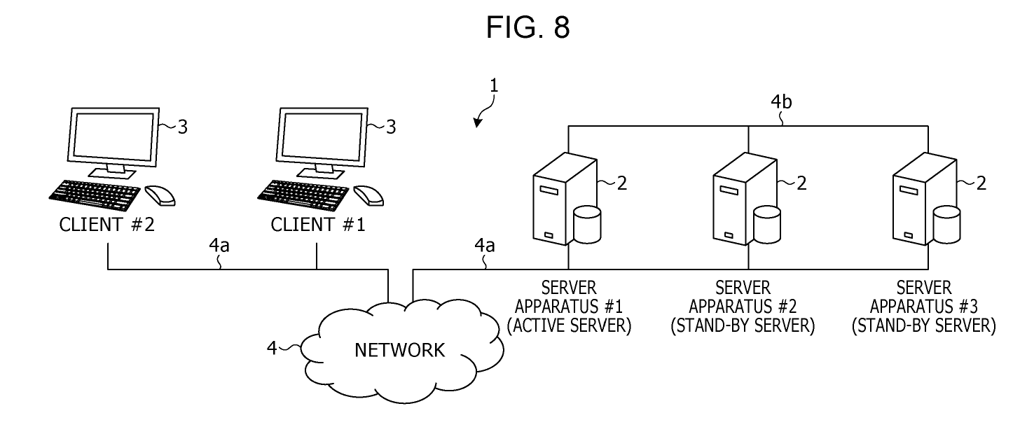

The configuration of the information processing system according to an embodiment will now be described. FIG. 8 is a diagram illustrating a configuration of the information processing system according to the embodiment. As illustrated in FIG. 8, the information processing system 1 according to an embodiment includes three server apparatuses 2 represented as server apparatuses #1 to #3, and two client apparatuses 3 represented as clients #1 and #2.

The client apparatus 3 is connected to the server apparatus 2 through a business LAN 4a for performing business communication and a network 4. The server apparatuses 2 are connected to each other through a synchronizing LAN 4b for performing mirroring. The server apparatus #1 operates as an active server, and the server apparatus #2 and the server apparatus #3 operate as stand-by servers. Although two client apparatuses 3 and two stand-by servers are illustrated in FIG. 8, the information processing system 1 may include three or more client apparatuses 3 and three or more stand-by servers.

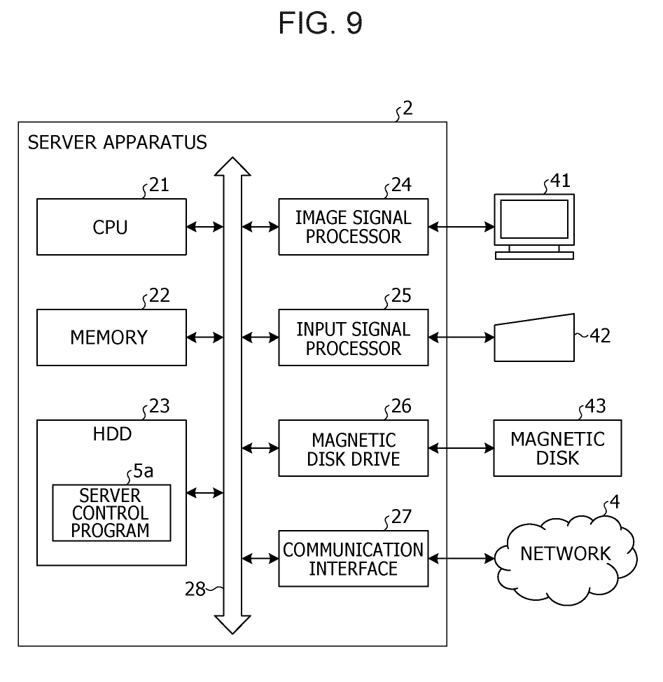

FIG. 9 is a diagram illustrating an example of a configuration of hardware in the server apparatus 2. As illustrated in FIG. 9, the server apparatus 2 includes a central processing unit (CPU) 21, a memory 22, a hard disk drive (HDD) 23, an image signal processor 24, an input signal processor 25, a magnetic disk drive 26, and a communication interface 27. The CPU is sometimes called a processor. The CPU 21, the memory 22, the HDD 23, the image signal processor 24, the input signal processor 25, the magnetic disk drive 26, and the communication interface 27 are connected to each other through a bus 28.

The CPU 21 is a central processor which reads programs from the memory 22, and executes the programs. The memory 22 is a random access memory (RAM) which stores the programs and the results during the execution of the programs. The HDD 23 is a disk device which stores programs and data. The HDD 23 stores a server control program 5a which controls the server apparatus 2.

The image signal processor 24 controls display on a display 41. The input signal processor 25 controls input from an input device 42. The magnetic disk drive 26 controls a magnetic disk 43. The communication interface 27 controls communication through the business LAN 4a and the network 4. The communication interface 27 also controls communication through the synchronizing LAN 4b.

The server control program 5a is stored in a magnetic disk such as a CD or a DVD, and is read from the magnetic disk to be installed in the server apparatus 2. Alternatively, the server control program 5a is stored in a database in another server apparatus connected through the network 4, and is read from the database to be installed in the server apparatus 2. The installed server control program 5a is read from the HDD 23 to the memory 22, and is executed by the CPU 21.

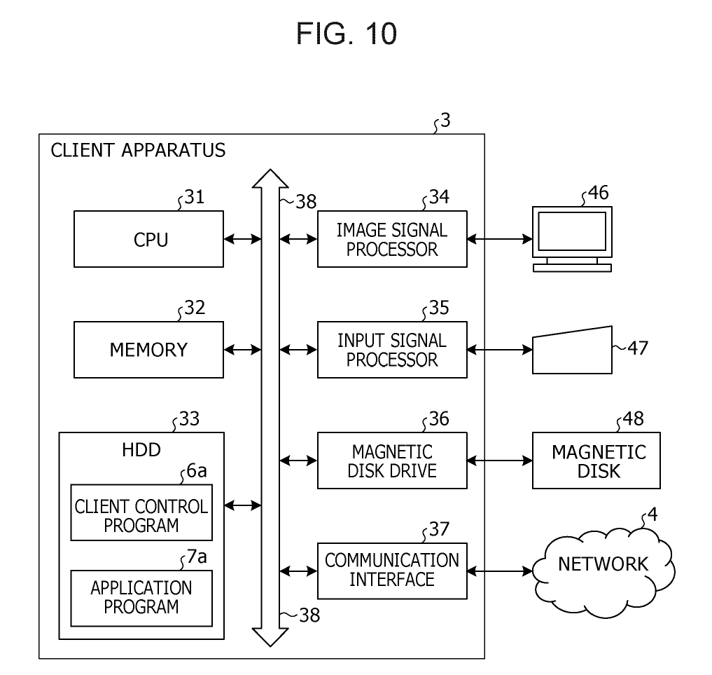

FIG. 10 is a diagram illustrating an example of a configuration of hardware of the client apparatus 3. As illustrated in FIG. 10, the client apparatus 3 includes a CPU 31, a memory 32, an HDD 33, an image signal processor 34, an input signal processor 35, a magnetic disk drive 36, and a communication interface 37. The CPU 31, the memory 32, the HDD 33, the image signal processor 34, the input signal processor 35, the magnetic disk drive 36, and the communication interface 37 are connected to each other through a bus 38.

The CPU 31 is a central processor which reads programs from the memory 32, and executes the programs. The memory 32 is a RAM which stores programs and the results during execution of the programs. The HDD 33 is a disk device which stores the programs and data. The HDD 33 stores a client control program 6a which controls the client apparatus 3. The HDD 33 also stores an application program 7a which is executed in the client apparatus 3.

The image signal processor 34 controls display on a display 46. The input signal processor 35 controls input from an input device 47. The magnetic disk drive 36 controls the magnetic disk 48. The communication interface 37 controls communication through the network 4.

The client control program 6a and the application program 7a are stored in a magnetic disk such as a CD or a DVD, and is read from the magnetic disk to be installed in the client apparatus 3. Alternatively, the client control program 6a and the application program 7a are stored in a database in another server apparatus connected through the network 4, and are read from the database to be installed in the client apparatus 3. The installed client control program 6a and application program 7a are read from the HDD 33 to the memory 32, and are executed by the CPU 31.

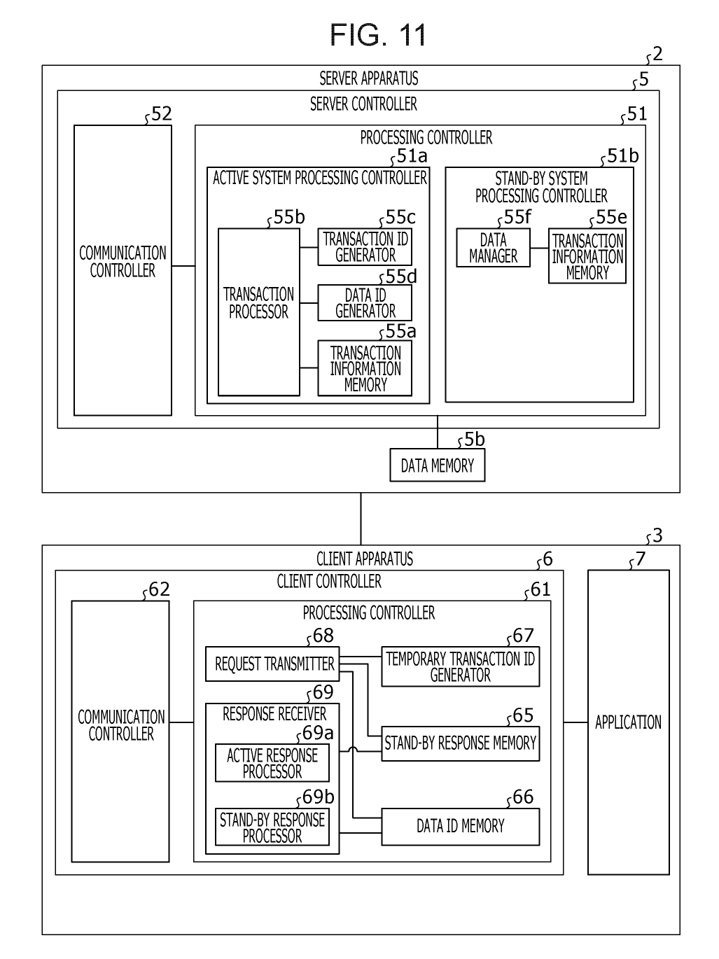

The functional configurations of the server apparatus 2 and the client apparatus 3 will now be described. FIG. 11 is a diagram illustrating functional configurations of the server apparatus 2 and the client apparatus 3. As illustrated in FIG. 11, the server apparatus 2 includes a data memory 5b and a server controller 5.

The data memory 5b stores data used by the application 7 which operates in the client apparatus 3. The data memory 5b is implemented on the memory 22. The data memory 5b may be implemented on the HDD 23. FIG. 12 is a diagram illustrating an example of the data memory 5b. As illustrated in FIG. 12, the data memory 5b stores the data in association with the data ID. The data ID is an identifier for identifying the data. For example, the data having the data ID “00000101” is “abcdef”.

The server controller 5 controls the server apparatus 2. The server controller 5 is implemented through the execution of the server control program 5a, which is illustrated in FIG. 9, by the CPU 21. The server controller 5 includes a processing controller 51 and a communication controller 52. The processing controller 51 controls the processing related with transactions. The communication controller 52 controls the communication between the client apparatus 3 and another server apparatus 2 using the communication interface 27.

The processing controller 51 includes an active system processing controller 51a and a stand-by system processing controller 51b. The active system processing controller 51a controls the processing related with transactions when the server apparatus 2 operates as an active server. The stand-by system processing controller 51b controls the processing related with transactions when the server apparatus 2 operates as a stand-by server.

The active system processing controller 51a includes a transaction information memory 55a, a transaction processor 55b, a transaction ID generator 55c, and a data ID generator 55d. The stand-by system processing controller 51b includes a transaction information memory 55e and a data manager 55f.

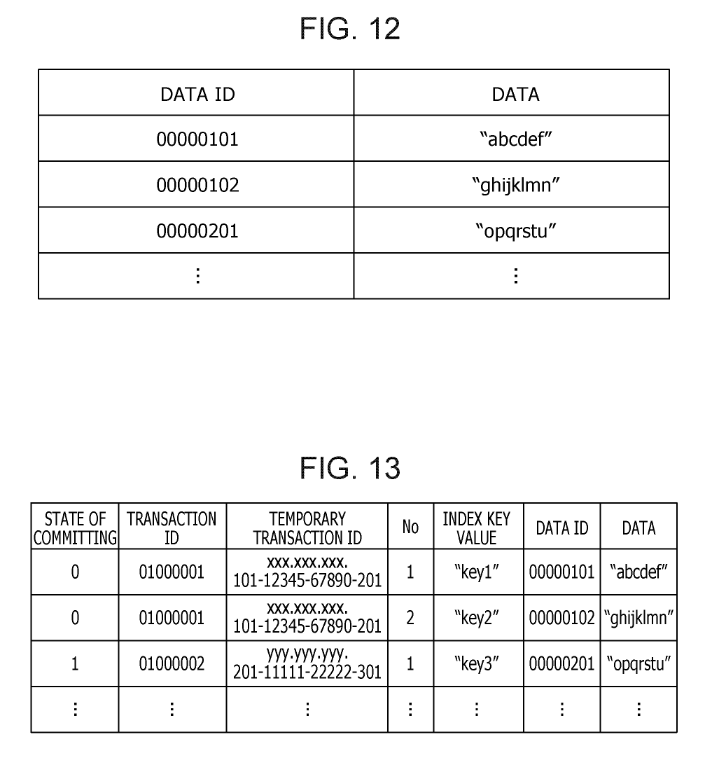

The transaction information memory 55a stores the information on transactions. FIG. 13 is a diagram illustrating an example of the transaction information memory 55a. As illustrated in FIG. 13, for each request message, the transaction information memory 55a stores the state of committing, the transaction ID, the temporary transaction ID, the serial number No, the index key value, the data ID, and the data in association with each other.

The state of committing represents whether the committing is completed or not. A state of committing of “1” represents the completion of the committing, and a state of committing of “0” represents the incompletion of the committing. The index key value is a value of the index key of the data. For example, the data of a request message having a transaction ID “01000001”, and a temporary transaction ID “xxx.xxx.xxx.101-12345-67890-201”, and a serial number No “1” is “abcdef”, in which the committing is not completed. The identifier of the data is “0000000101”, and the index key value is “key1”. In FIGS. 1A to 7C, the state of committing and the index key value are omitted.

The transaction processor 55b receives the request message from the client apparatus 3, performs the processing according to the request message, and transmits the response message to the client apparatus 3.

Specifically, when the transaction processor 55b receives a request message which demands addition of the data, the transaction processor 55b executes transaction processing. The transaction processing includes exclusion processing. The transaction processor 55b then instructs the transaction ID generator 55c to generate the transaction ID, and instructs the data ID generator 55d to generate the data ID.

The transaction processor 55b then updates the transaction information memory 55a based on the generated transaction ID and data ID and the information on the request message. The transaction processor 55b then contains the generated transaction ID and data ID in the response message, and transmits the response message to the client apparatus 3.

When the transaction processor 55b receives a request message which demands update of the data, the transaction processor 55b executes the transaction processing. The transaction processor 55b then instructs the data ID generator 55d to generate the data ID, and updates the transaction information memory 55a based on the generated data ID and the information on the request message. The transaction processor 55b then contains the generated data ID in the response message, and transmits the response message to the client apparatus 3.

When the transaction processor 55b receives a request message which demands committing, the transaction processor 55b performs the commit processing to reflect the information stored in the transaction information memory 55a to the data memory 5b. For the transaction subjected to the commit processing, the transaction processor 55b retains the information stored in the transaction information memory 55a, rather than deletes it. When the transaction processor 55b receives the next request message from the same client apparatus 3, the transaction processor 55b deletes the information of the transaction subjected to the commit processing, the information being stored in the transaction information memory 55a.

When the mirroring flag of the commit request is “ON”, the transaction processor 55b transmits the information stored in the transaction information memory 55a to the stand-by server to instruct the committing. Using the transaction information memory 55a, the transaction processor 55b detects that a request message including the data which is being processed by the stand-by server based on the request from the client apparatus 3 is received from another client apparatus 3. The transaction processor 55b then responds to the another client apparatus 3 using a response message including the information of the precedent transaction.

The transaction ID generator 55c generates the transaction ID based on the instruction from the transaction processor 55b. The data ID generator 55d generates the data ID based on the instruction from the transaction processor 55b.

The transaction information memory 55e stores the information on the transaction. The transaction information memory 55e has the same data structure as that of the transaction information memory 55a.

The data manager 55f receives a request message from the client apparatus 3, performs the processing according to the request message, and transmits the response message to the client apparatus 3. Specifically, when the transaction processor 55b receives a request message which demands a data manipulation, the transaction processor 55b updates the transaction information memory 55e based on the information contained in the request message, and transmits the response message to the client apparatus 3.

When the request message contains the transaction ID and data ID related with the previous request message, the data manager 55f updates the information on the previous request message stored in the transaction information memory 55e. Namely, the data manager 55f adds the transaction ID to transaction information memory 55e when the transaction ID is empty in the information related with the previous request message stored in the transaction information memory 55e, and adds the data ID to transaction information memory 55e when the data ID is empty.

When from the client apparatus 3, the data manager 55f receives a request message which demands committing, the data manager 55f performs the commit processing to reflect the information stored in the transaction information memory 55e to the data memory 5b. For the transaction subjected to the commit processing, the data manager 55f retains the information stored in the transaction information memory 55e, rather than deletes it. When the data manager 55f receives the next request message from the same client apparatus 3, the data manager 55f deletes the information on the transaction subjected to the commit processing, the information being stored in the transaction information memory 55e.

When the mirroring flag of the commit request is “ON”, the data manager 55f waits for an instruction from the active server without performing the commit processing. When the data manager 55f receives the instruction for mirroring from the active server, the data manager 55f performs the commit processing based on the information transmitted from the active server.

The data manager 55f also compares the index key value or data to determine whether the transaction information memory 55e stores the data having a possibility that the data is the same as the data to be processed according to the request message from the client apparatus 3. When the transaction information memory 55e stores the data having a possibility that the data is the same as the data to be processed according to the request message from the client apparatus 3, the data manager 55f adds the temporary transaction ID corresponding to the data having a possibility that the data is the same as the data to be processed according to the request message from the client apparatus 3, and responds to the client apparatus 3.

The client apparatus 3 includes the client controller 6 which controls the client apparatus 3, and the application 7. The client controller 6 is implemented through the execution of the client control program 6a (illustrated in FIG. 10) by the CPU 31. The application 7 is implemented on the client apparatus 3 through the execution of the application program 7a (illustrated in FIG. 10) by the CPU 31.

The client controller 6 includes a processing controller 61 and a communication controller 62. The processing controller 61 controls the processing related with transactions. The communication controller 62 controls the communication with the server apparatus 2 using the communication interface 37.

The processing controller 61 includes a stand-by response memory 65, a data ID memory 66, a temporary transaction ID generator 67, a request transmitter 68, and a response receiver 69.

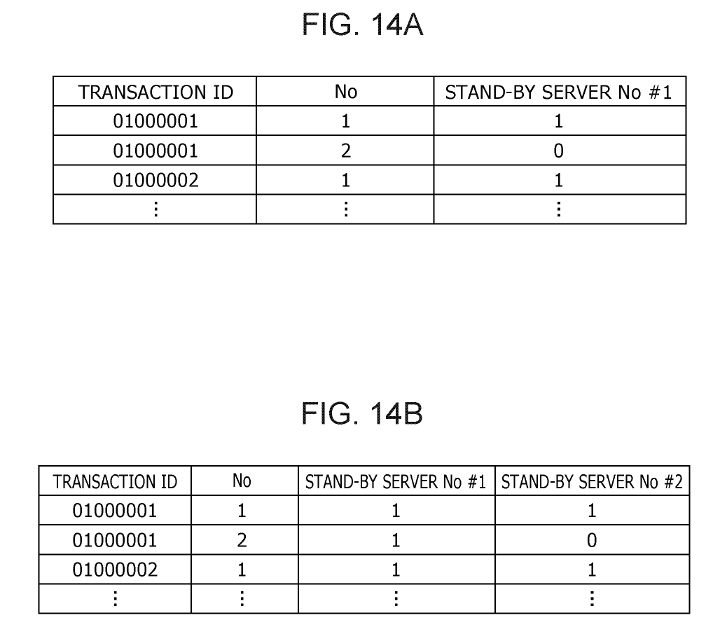

The stand-by response memory 65 stores the information on the state of the response from the stand-by server. FIGS. 14A and 14B are diagrams illustrating examples of the stand-by response memory 65. FIG. 14A illustrates an example in which a single stand-by server is used, and FIG. 14B illustrates an example in which two stand-by servers are used.

As illustrated in FIGS. 14A and 14B, the stand-by response memory 65 stores the transaction ID, the serial number No, and the stand-by server No#1 for each request message. In use of two stand-by servers, the stand-by response memory 65 further stores the stand-by server No#2.

The stand-by server No#1 and the stand-by server No#2 are numbers for identifying the stand-by servers whose responses are received by the client apparatus 3. If no response is received, the stand-by server No#1 and the stand-by server No#2 are empty. For example, in FIG. 14A, a request message having a transaction ID “01000001” and a serial number No “1” has a response from the client apparatus 3 having a stand-by server No#1 having “1”.

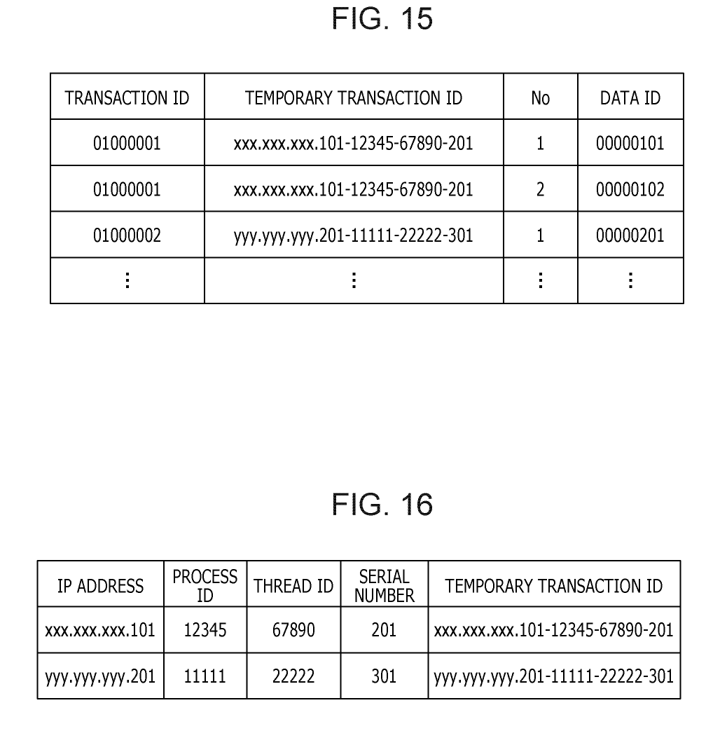

The data ID memory 66 stores the data ID and the information related with the data ID. FIG. 15 is a diagram illustrating an example of the data ID memory 66. As illustrated in FIG. 15, the data ID memory 66 stores the transaction ID, the temporary transaction ID, the serial number No, and the data ID in association with each other. For example, the data of a request message having a transaction ID “01000001”, a temporary transaction ID “xxx.xxx.xxx.101-12345-67890-201”, and a serial number No “1” has an identifier of “00000101”.

The temporary transaction ID generator 67 generates a temporary transaction ID. FIG. 16 is a diagram illustrating an example of the temporary transaction ID. As illustrated in FIG. 2, the temporary transaction ID is configured with an IP address, a process ID, a thread ID, and a serial number. As illustrated in FIG. 16, if the IP address is “xxx.xxx.xxx.101”, the process ID is “12345”, the thread ID is “67890”, and the serial number is “201”, the temporary transaction ID has a value obtained by linking these values with “-”. Namely, the temporary transaction ID is “xxx.xxx.xxx.101-12345-67890-201”.

The request transmitter 68 creates a request message, and transmits the request message to the active server and the stand-by server. Specifically, during the first transmission of a request message for a transaction, the request transmitter 68 instructs the temporary transaction ID generator 67 to generate the temporary transaction ID, and writes the temporary transaction ID and the serial number in the stand-by response memory 65 and the data ID memory 66. The request transmitter 68 then adds the temporary transaction ID to the request message, and transmits the request message to the active server and the stand-by server.

During the second and subsequent transmissions of the request messages, the request transmitter 68 refers to the data ID memory 66, adds the transaction ID and the data ID, which have been transmitted in the response message to the last request message transmitted from the active server, to the request message, and transmits the request message to the active server and the stand-by server.

If a commit request message is transmitted, the request transmitter 68 checks the stand-by response memory 65. If the responses are received from all of the stand-by servers, the request transmitter 68 sets the mirroring commit flag to “0”. If no response is received from any one of these stand-by servers, the request transmitter 68 sets the mirroring commit flag to “1”. The request transmitter 68 then adds the transaction ID and the data ID, which have been transmitted in the response message to the last request message transmitted from the active server, to the request message, and transmits the request message to the active server and the stand-by server.

The response receiver 69 receives the response message transmitted from the server apparatus 2, and performs processing. The response receiver 69 includes an active response processor 69a and a stand-by response processor 69b. The active response processor receives the response message transmitted from the active server, and performs processing. The stand-by response processor 69b receives the response message transmitted from the stand-by server, and performs processing.

Specifically, when a response message to the data manipulation is received from the active server, the active response processor 69a stores the transaction ID and the data ID contained in the response message in the data ID memory 66 in association with the temporary transaction ID. During the first reception of the transaction ID from the active server, the active response processor 69a overwrites the temporary transaction ID in the stand-by response memory 65 with the transaction ID.

If the response message for the data manipulation is not received for a predetermined time from the active server, the active response processor 69a retransmits the request message for the data manipulation. If the active server does not respond even after the request message has been retransmitted several times, the active response processor 69a rolls back the processing to recover from an error.

If the response message to the request message contains the information on the precedent transaction transmitted from the another client apparatus 3, the active response processor 69a notifies the stand-by response processor 69b of the information on the precedent transaction.

If the response is received from the stand-by server, the stand-by response processor 69b adds the identifier of the stand-by server having transmitted the response to the server No of the stand-by response memory 65. If the response is received from the stand-by server, the stand-by response processor 69b deletes the information of the precedent serial number from the data ID memory 66.

If the response contains the information on the precedent transaction transmitted from another client apparatus 3, the stand-by response processor 69b determines whether the temporary transaction ID contained in the precedent transaction information notified by the active response processor 69a matches with the temporary transaction ID contained in the response. If the two temporary transaction IDs match with each other, the stand-by response processor 69b instructs the active server and the stand-by server to roll back, and requests the application 7 to retry.

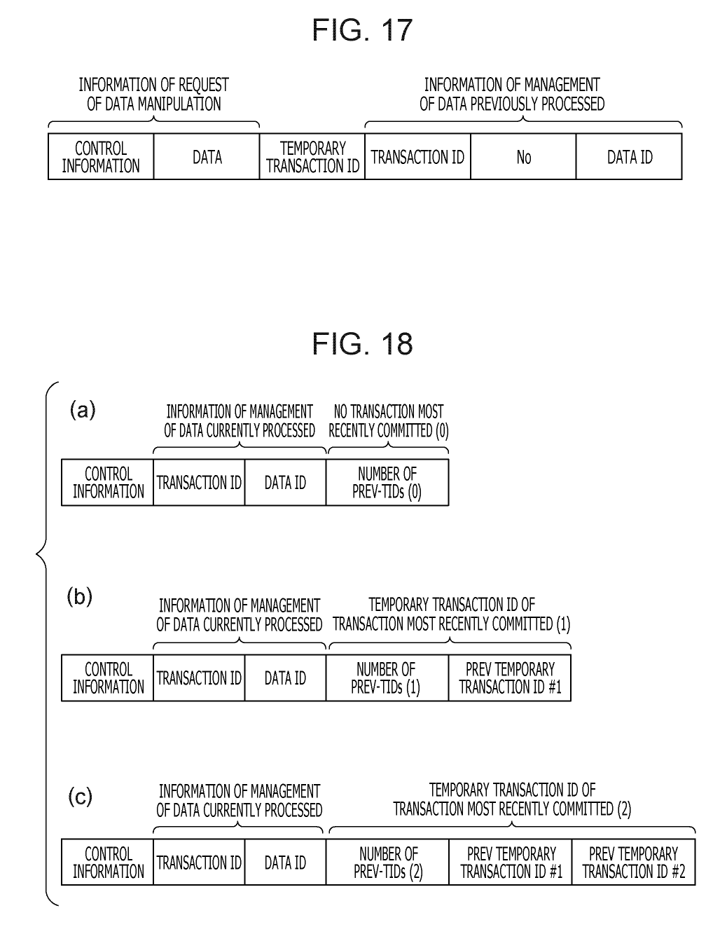

An example of a message will now be described using FIGS. 17 to 20. FIG. 17 is a diagram illustrating an example of a request message (data manipulation). As illustrated in FIG. 17, a request message (data manipulation) contains control information, data, a temporary transaction ID, a transaction ID, a serial number No, and a data ID.

The control information indicates that the data manipulation is one of addition, update, and deletion. The data represents the target data to be operated. The control information and the data represent the information on the data manipulation request. The transaction ID, the serial number No, and the data ID represent the information of management of the data previously processed. In FIGS. 1A to 7C, the control information is omitted.

FIG. 18 is a diagram illustrating an example of a response message (data manipulation). FIG. 18(a) illustrates the case where there is no transaction most recently committed. FIG. 18(b) illustrates the case where there is one transaction most recently committed. FIG. 18(c) illustrates the case where there are two transactions most recently committed.

As illustrated in FIG. 18, the response message (data manipulation) contains the control information, the transaction ID, the data ID, and the number of PREV-TIDs. If there is one transaction most recently committed, the response message (data manipulation) contains the PREV temporary transaction ID #1. If there are two transactions most recently committed, the response message (data manipulation) contains the PREV temporary transaction ID #1 and the PREV temporary transaction ID #2.

In FIG. 18, the transaction ID and the data ID represent the information of management of data currently processed. The number of PREV-TIDs represents the number of most recently committed transactions. The number is “0” in FIG. 18(a), “1” in FIG. 18(b), and “2” in FIG. 18(c). The PREV temporary transaction ID #1 and the PREV temporary transaction ID #2 each represent the temporary transaction ID of the most recently committed transaction.

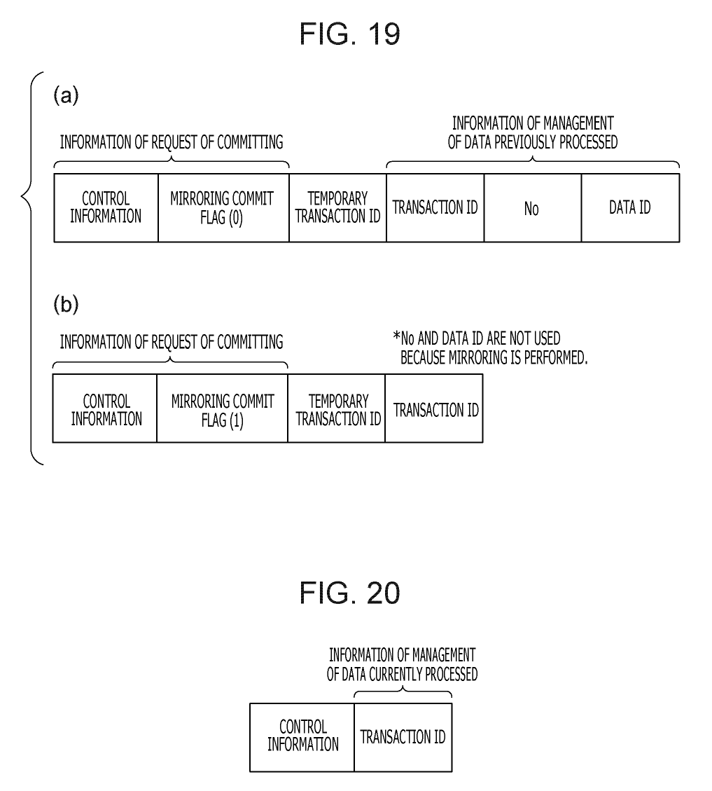

FIG. 19 is a diagram illustrating an example of a request message (commit). FIG. 19(a) illustrates the case where the mirroring commit flag is off (0), and FIG. 19(b) illustrates the case where the mirroring commit flag is on (1). As illustrated in FIG. 19, the request message (commit) contains control information, a mirroring commit flag, a temporary transaction ID, a transaction ID, a serial number No, and a data ID.

The control information and the mirroring commit flag represent the information of request of committing. The transaction ID, the serial number No, and the data ID represent the information of management of the data previously processed. If mirroring is performed, the serial number No and the data ID are not used.

FIG. 20 is a diagram illustrating an example of a response message (commit). As illustrated in FIG. 20, the response message (commit) contains control information and a transaction ID. The transaction ID represents the information of management of the data currently processed.

The entire flow of the processing by the information processing system 1 will now be described. An example in which the client #1 is a single client apparatus 3, and an example in which the client #1 and the client #2 are two client apparatuses 3 will be described below.

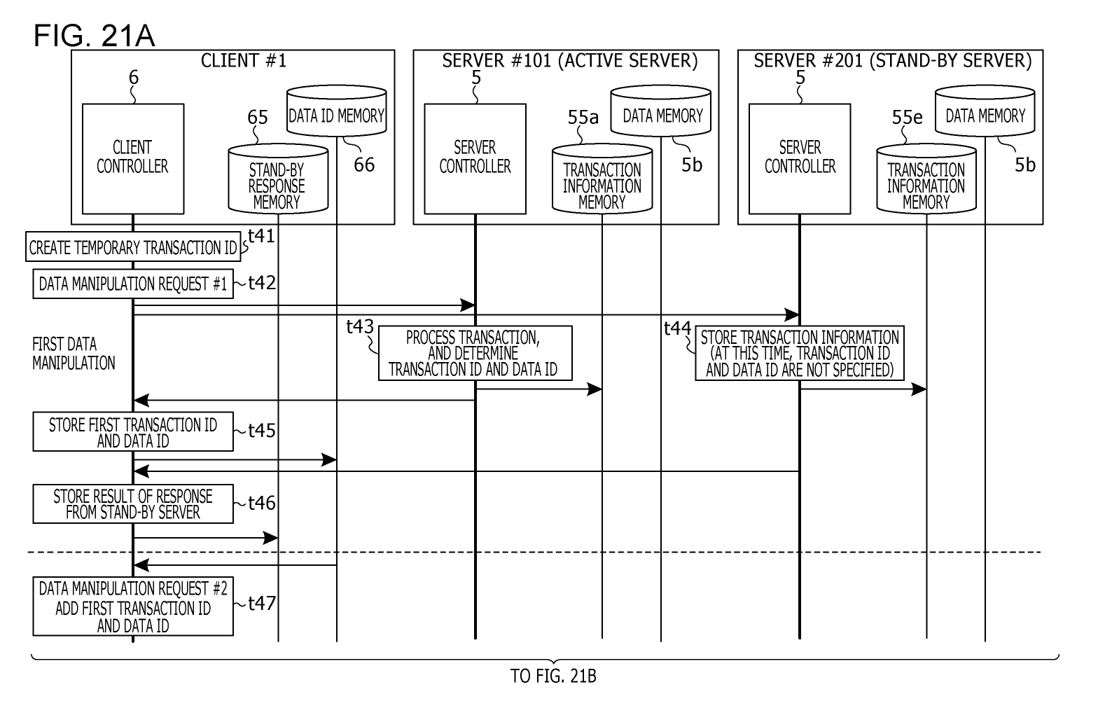

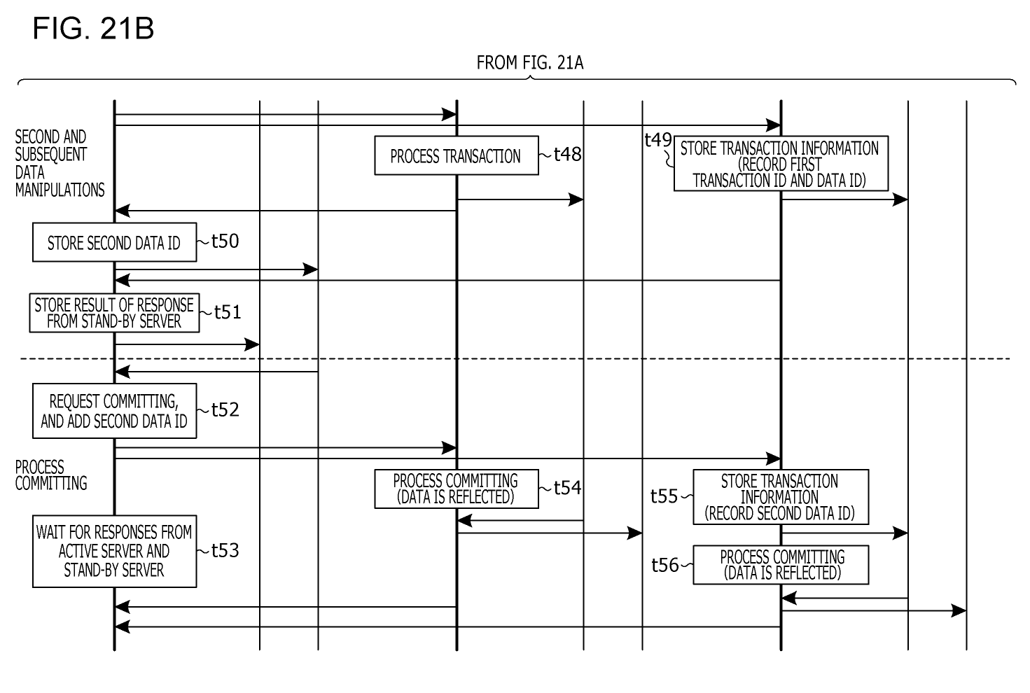

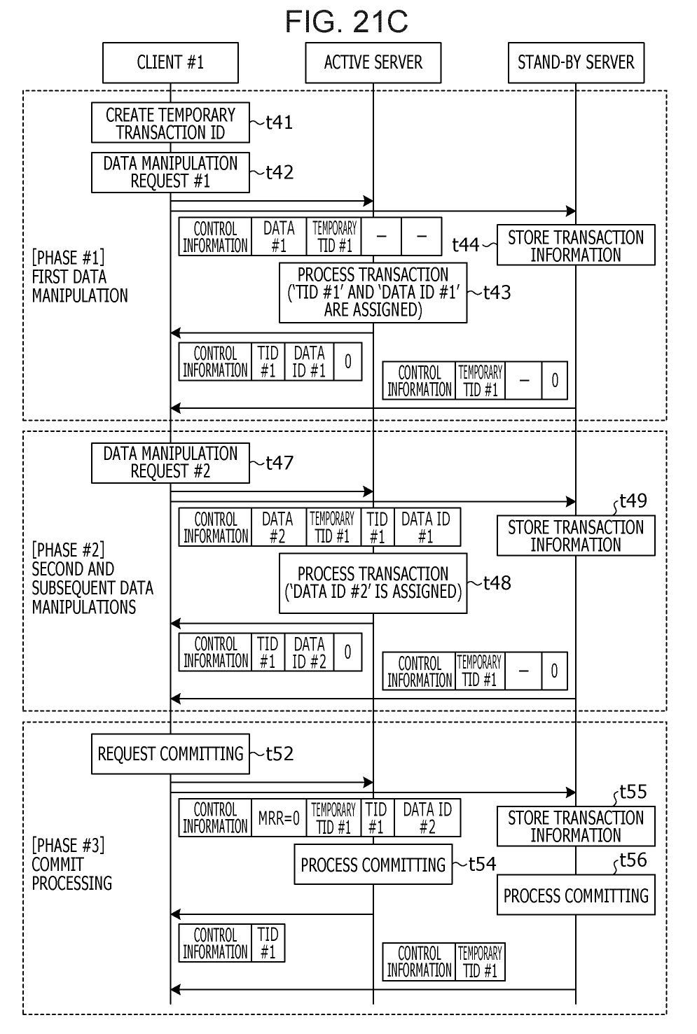

FIG. 21A is a first diagram illustrating the entire flow. As illustrated in FIG. 21A, the client controller 6 in the client #1 creates a temporary transaction ID (t41), and transmits a data manipulation request #1 to the active server and the stand-by server (t42). The transmission of data to the active server and the stand-by server may be performed through simultaneous communication such as multicast communication.

The server controller 5 in the active server then performs transaction processing, and determines the transaction ID and the data ID (t43). On the other hand, the server controller 5 in the stand-by server stores the transaction information (t44). Herein, the transaction information refers to the information stored in the transaction information memory 55e for each request message. At this time, however, the transaction ID and the data ID are not specified yet.

When the response message from the active server is received, the client controller 6 stores the first transaction ID and the data ID in the data ID memory 66 (t45). When the response from the stand-by server is received, the client controller 6 stores the result of response by the stand-by server in the stand-by response memory 65 (t46). The processing from t41 to t46 is processing corresponding to the first data manipulation.

The client controller 6 transmits the data manipulation request #2 to the active server and the stand-by server (t47). At this time, the client controller 6 adds the first transaction ID and the data ID. FIG. 21B is a second diagram illustrating the entire flow. As illustrated in FIG. 21B, the server controller 5 in the active server performs the transaction processing (t48). On the other hand, the server controller 5 in the stand-by server stores the transaction information (t49). At this time, the server controller 5 in the stand-by server records the first transaction ID and the data ID.

When the response message from the active server is received, the client controller 6 stores the second data ID in the data ID memory 66 (t50). When the response from the stand-by server is received, the client controller 6 stores the result of response by the stand-by server in the stand-by response memory 65 (t51). The processing from t47 to t51 is processing corresponding to the second data manipulation. If the data manipulation is repeated, the processing from t47 to t51 is repeated.

The client controller 6 then transmits the commit request to the active server and the stand-by server (t52). At this time, the client controller 6 adds the second data ID. The client controller 6 then waits for the responses coming from both of the active server and the stand-by server (t53).

When the commit request is received, the server controller 5 in the active server performs the commit processing (t54). When the commit request is received, the server controller 5 in the stand-by server stores the transaction information (t55). At this time, the server controller 5 in the stand-by server records the second data ID. The server controller 5 in the stand-by server performs the commit processing (t56). The processing from t52 to t56 is commit processing.

FIG. 21C is a third diagram illustrating the entire flow. Unlike FIGS. 21A and 21B, FIG. 21C illustrates messages, and omits the processing of the client #1 storing the data. In FIG. 21C, the temporary TID represents a temporary transaction ID, and the TID represents a transaction ID. MRR represents a mirroring commit flag.

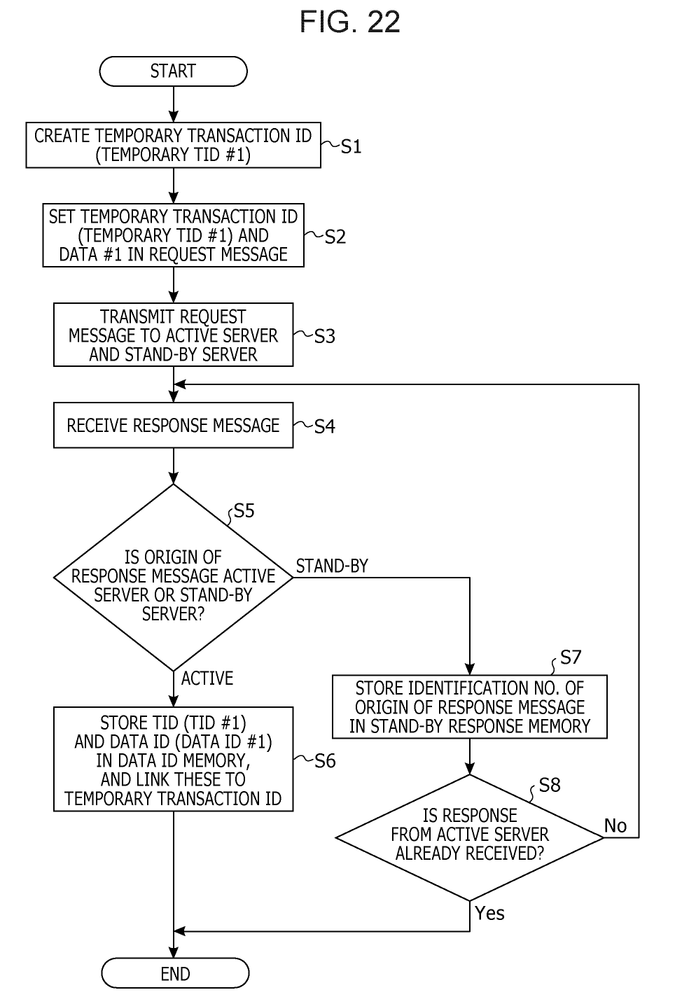

In FIG. 21C, the processing corresponding to the first data manipulation is defined as a phase #1, the processing corresponding to the second and subsequent data manipulations is defined as a phase #2, and the commit processing is defined as a phase #3. FIGS. 22 to 30 below illustrate the flow of the processings of the client #1, the active server, and the stand-by server in the respective phases.

FIG. 22 is a flowchart illustrating the flow of the first data manipulation processing (phase #1) by the client #1. As illustrated in FIG. 22, the client #1 creates a temporary transaction ID (temporary TID #1) (Step S1), and sets a temporary transaction ID (temporary TID #1) and data #1 in a request message (Step S2).

The client #1 then transmits the request message to the active server and the stand-by server (Step S3). Subsequently, when a response message is received (Step S4), the client #1 determines whether the origin of the response message is the active server or the stand-by server (Step S5). When the origin of the response message is the active server, the client #1 stores the TID (TID #1) and the data ID (data ID #1) in the data ID memory 66, and links these to the temporary transaction ID (Step S6).

When the origin of the response message is the stand-by server, the client #1 stores the identification number of the origin in the stand-by response memory 65 (Step S7), and determines whether the response from the active server is already received or not (Step S8). If the response from the active server is already received, the client #1 terminates the processing in the phase #1. If the response from the active server is not already received, the processing returns to Step S4.

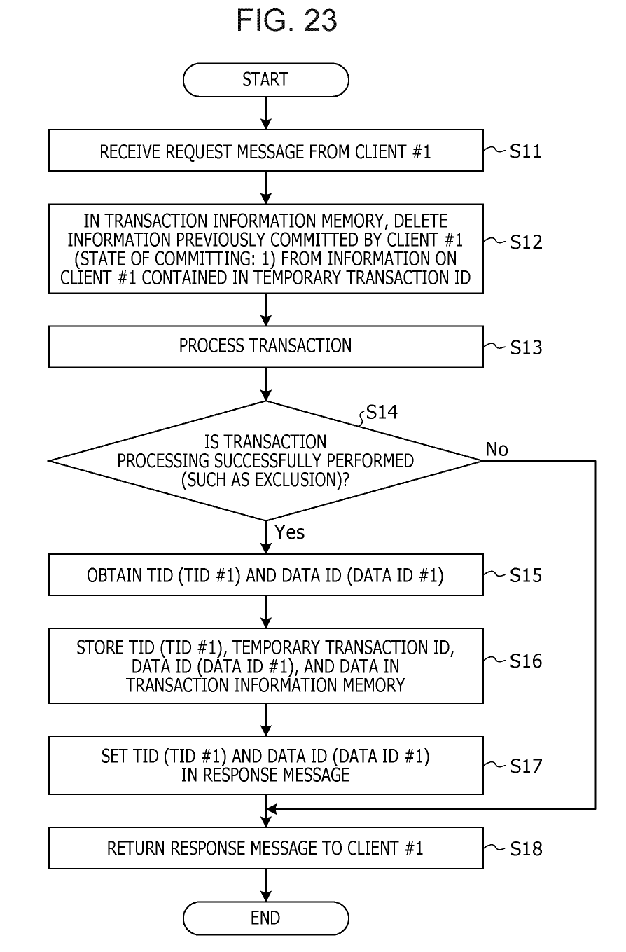

FIG. 23 is a flowchart illustrating the flow of the first data manipulation processing (phase #1) by the active server. As illustrated in FIG. 23, the active server receives the request message from the client #1 (Step S11). In the transaction information memory 55a, the active server then deletes the information previously committed by the client #1 (state of committing: “1”) from the information on the client #1 contained in the temporary transaction ID (Step S12).

The active server then performs the transaction processing (Step S13), and determines whether the transaction processing is successfully performed or not (Step S14). Herein, the determination whether the transaction processing is successful or failed is determined according to whether the exclusion processing is successful or not. If the transaction processing is not successfully performed, the active server goes to Step S18.

If the transaction processing is successfully performed, the active server obtains the TID (TID #1) and the data ID (data ID #1) (Step S15). The active server then stores the TID (TID #1), the temporary transaction ID, the data ID (data ID #1), and the data in the transaction information memory 55a (Step S16). The active server then sets the TID (TID #1) and the data ID (data ID #1) in the response message (Step S17), and returns the response message to the client #1 (Step S18).

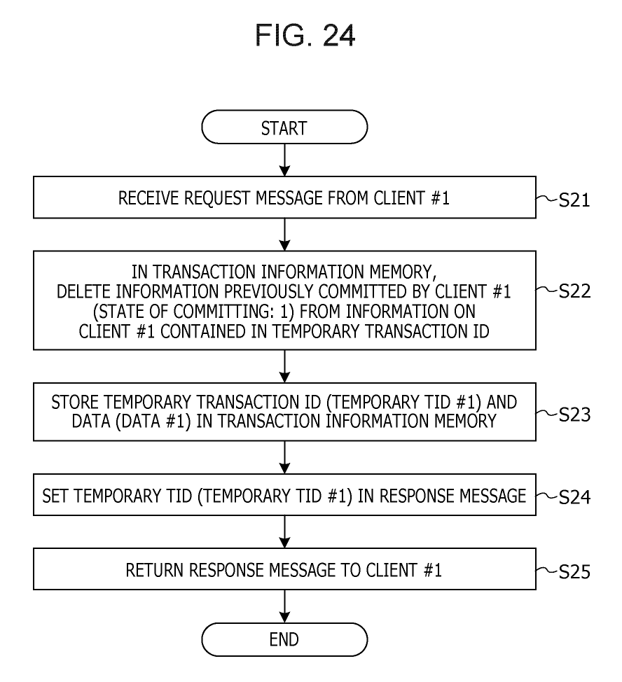

FIG. 24 is a flowchart illustrating a flow of the first data manipulation processing (phase #1) by the stand-by server. As illustrated in FIG. 24, the stand-by server receives the request message from the client #1 (Step S21). In the transaction information memory 55e, the stand-by server deletes the information previously committed by the client #1 (state of committing: “1”) from the information on the client #1 contained in the temporary transaction ID (Step S22).

The stand-by server then stores the temporary transaction ID (temporary TID #1) and the data in the transaction information memory 55e (Step S23). The stand-by server then sets the temporary TID (temporary TID #1) in the response message (Step S24), and returns the response message to the client #1 (Step S25).

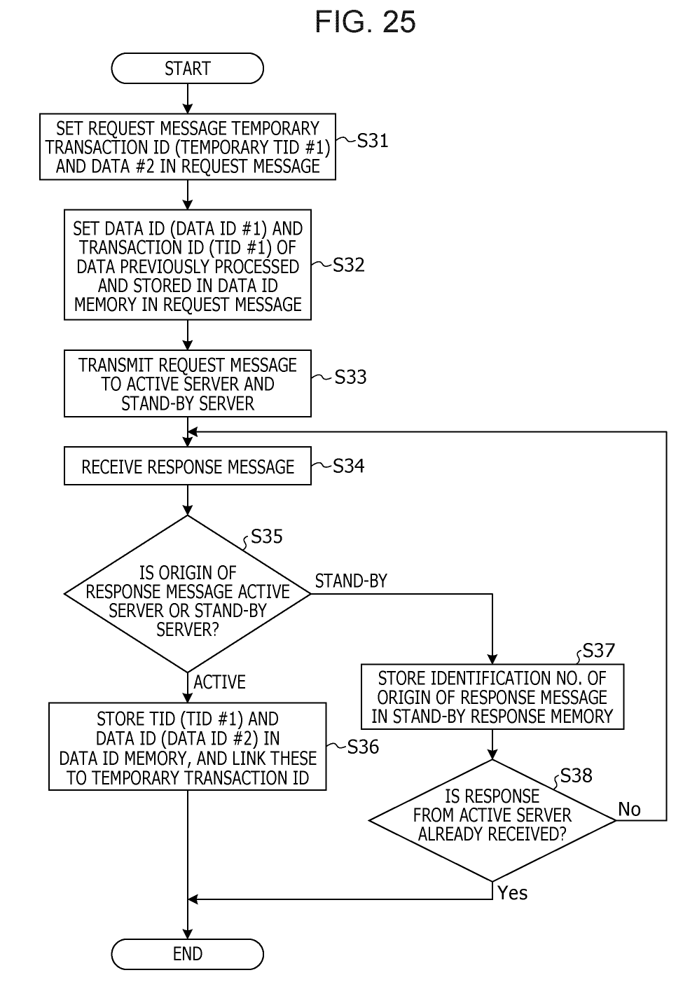

FIG. 25 is a flowchart illustrating a flow of the second and subsequent data manipulation processings (phase #2) by the client #1. As illustrated in FIG. 25, the client #1 sets the temporary transaction ID (temporary TID #1) and the data #2 in the request message (Step S31). The client #1 then sets the data ID (data ID #1) previously processed and stored in the data ID memory 66 and the transaction ID (TID #1) in the request message (Step S32).

The client #1 then transmits the request message to the active server and the stand-by server (Step S33). Subsequently, when the response message is received (Step S34), the client #1 determines whether the origin of the response message is the active server or the stand-by server (Step S35). If the origin of the response message is the active server, the client #1 stores the TID (TID #1) and the data ID (data ID #2) in the data ID memory 66, and links these to the temporary transaction ID (Step S36).

If the origin of the response message is the stand-by server, the client #1 stores the identification number of the origin in the stand-by response memory 65 (Step S37), and determines whether the response from the active server is already received or not (Step S38). If the response from the active server is already received, the client #1 terminates the processing in the phase #1. If the response from the active server is not already received, the processing returns to Step S34.

Thus, when the client #1 receives the response from the active server, the client #1 proceeds the processing without waiting for the response from the stand-by server (without performing verification of the transmission or control of retry), achieving processing at higher speed. If there is no response from the stand-by server until the commit request, the client #1 sets the mirroring commit flag to “1”, and transmits the commit request (mirroring commit flag in the usual processing is “0”), thereby verifying the response from the stand-by server in a non-synchronizing manner. The client #1 may wait for the stand-by server in a synchronizing manner.

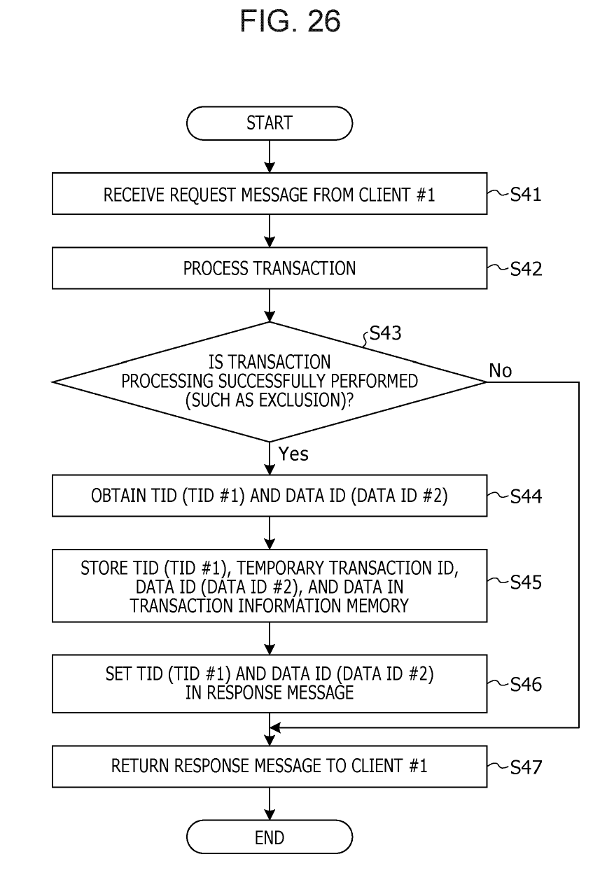

FIG. 26 is a flowchart illustrating a flow of the second and subsequent data manipulation processings (phase #2) by the active server. As illustrated in FIG. 26, the active server receives the request message from the client #1 (Step S41). The active server then performs the transaction processing (Step S42), and determines whether the transaction processing is successfully performed or not (Step S43). If the transaction processing is not successfully performed, the active server goes to Step S47.

If the transaction processing is successfully performed, the active server obtains the TID (TID #1) and the data ID (data ID #2) (Step S44). The active server then stores the TID (TID #1), the temporary transaction ID, the data ID (data ID #2), and the data in the transaction information memory 55a (Step S45). The active server then sets the TID (TID #1) and the data ID (data ID #2) in the response message (Step S46), and returns the response message to the client #1 (Step S47).

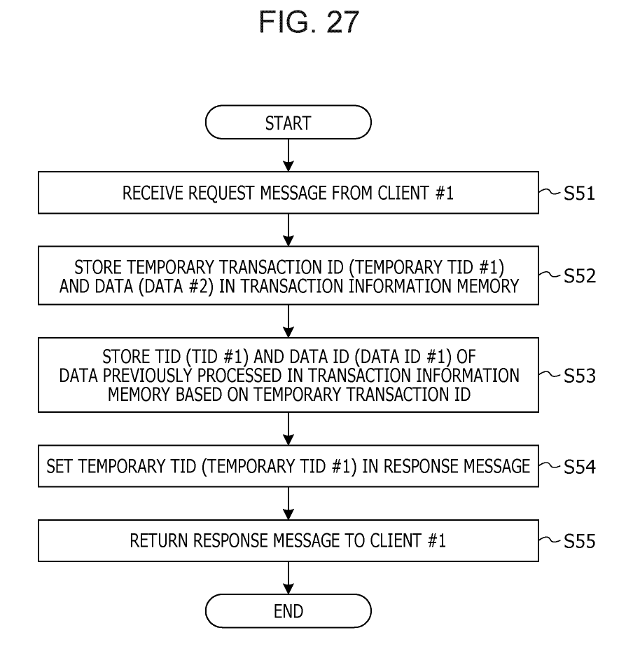

FIG. 27 is a flowchart illustrating a flow of the second and subsequent data manipulation processings (phase #2) by the stand-by server. As illustrated in FIG. 27, the stand-by server receives the request message from the client #1 (Step S51). The stand-by server then stores the temporary transaction ID (temporary TID #1) and the data (data #2) in the transaction information memory 55e (Step S52).

The stand-by server then stores the TID previously processed (TID #1) and the data ID (data ID #1) in the transaction information memory 55e based on the temporary transaction ID (Step S53). The stand-by server then sets the temporary TID (temporary TID #1) in the response message (Step S54), and returns the response message to the client #1 (Step S55).

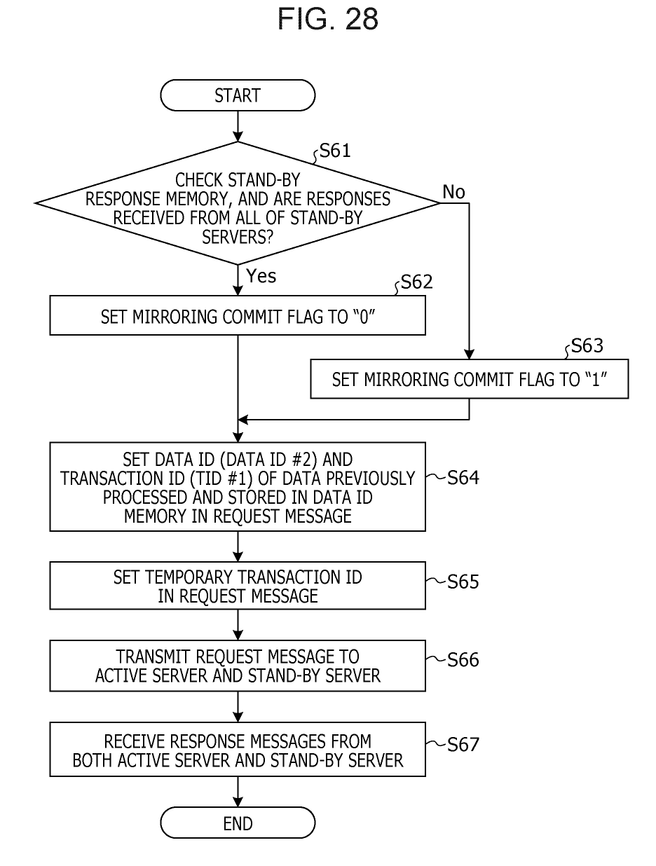

FIG. 28 is a flowchart illustrating a flow of the commit processing (phase #3) by the client #1. As illustrated in FIG. 28, the client #1 checks the stand-by response memory 65 to determine whether the responses are received from all of the stand-by servers (Step S61). If the responses are received from all of the stand-by servers, the client #1 sets the mirroring commit flag to “0” (Step S62). If no response is received from any one of these stand-by servers, the client #1 sets the mirroring commit flag to “1” (Step S63).

The client #1 then sets the data ID previously processed (data ID #2) and the transaction ID (TID #1), which are stored in the data ID memory 66, in the request message (Step S64). The client #1 then sets the temporary transaction ID in the request message (Step S65).

The client #1 then transmits the request message to the active server and the stand-by server (Step S66). Subsequently, the client #1 receives the response messages from both of the active server and the stand-by server (Step S67).

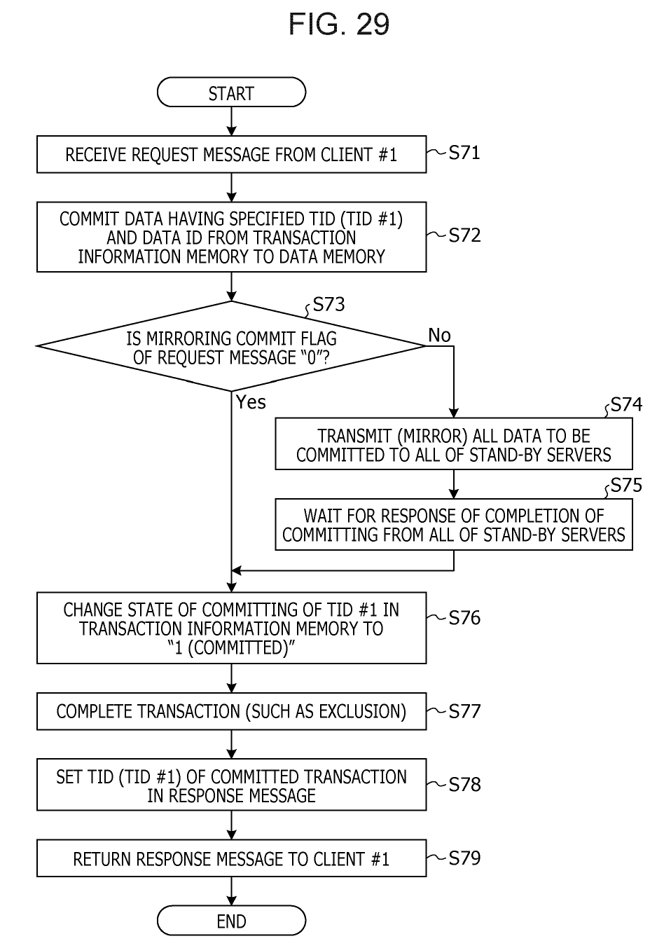

FIG. 29 is a flowchart illustrating a flow of the commit processing (phase #3) by the active server. As illustrated in FIG. 29, the active server receives a request message from the client #1 (Step S71), and commits the data having a specified TID (TID #1) and the data ID from the transaction information memory 55a to the data memory 5b (Step S72).

The active server then determines whether the mirroring commit flag of the request message is “0” or not (Step S73). If the mirroring commit flag is “0”, the processing goes to Step S76. If the mirroring commit flag is not “0”, the active server transmits all target data for committing to all of the stand-by servers (mirroring) (Step S74). The active server then waits for the response from the stand-by server indicating the completion of committing (Step S75).

The active server then updates the state of committing of the TID #1 in the transaction information memory 55a to “1” (committed) (Step S76), and terminates the transaction (Step S77). The processing to terminate the transaction includes cancellation of exclusion. The active server then sets the TID (TID #1) of the committed transaction in the response message (Step S78), and returns the response message to the client #1 (Step S79).

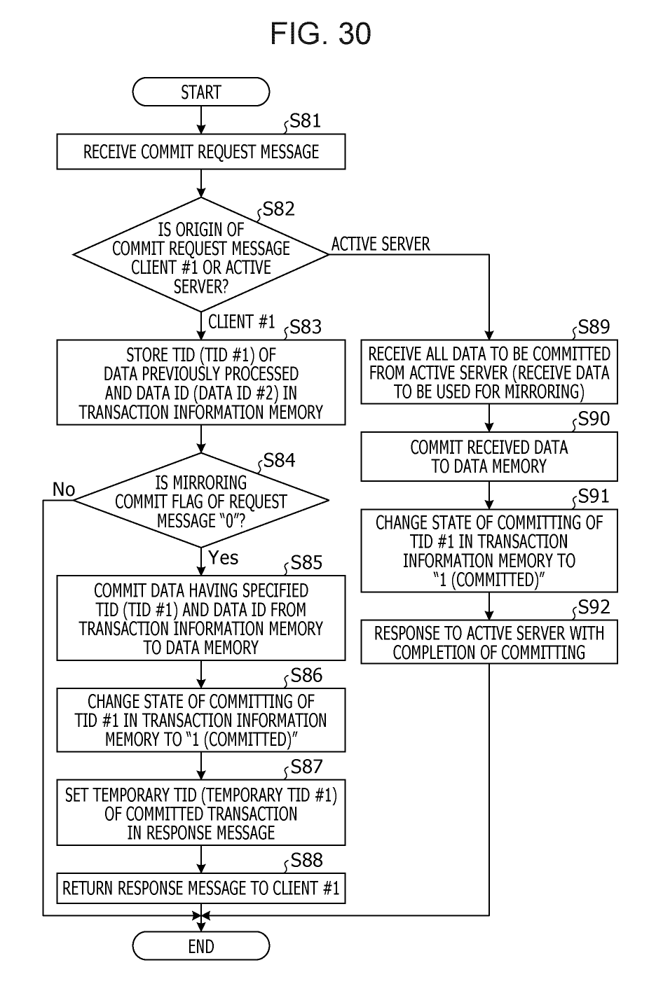

FIG. 30 is a flowchart illustrating a flow of the commit processing (phase #3) by the stand-by server. As illustrated in FIG. 30, the stand-by server receives the request message (Step S81), and determines whether the origin of the commit request message is the client #1 or the active server (Step S82).

If the origin of the commit request message is the client #1, the stand-by server stores the TID (TID #1) previously processed and the data ID (data ID #2) in the transaction information memory 55e (Step S83). The stand-by server then determines whether the mirroring commit flag of the request message is “0” or not (Step S84). If the mirroring commit flag is not “0”, the stand-by sever terminates the processing.

If the mirroring commit flag is “0”, the stand-by server commits the data having the specified TID (TID #1) and the data ID from the transaction information memory 55e to the data memory 5b (Step S85).

The stand-by server then changes the state of committing of the TID #1 in the transaction information memory 55e to “1” (committed) (Step S86). The stand-by server then sets the temporary TID (temporary TID #1) of the committed transaction in the response message (Step S87), and returns the response message to the client #1 (Step S88).

If the origin of the commit request message is the active server, the stand-by server receives all target data for committing from the active server (Step S89). Namely, the stand-by server receives the data used for mirroring from the active server. The stand-by server commits the received data to the data memory 5b (Step S90). The stand-by server then changes the state of committing of the TID #1 in the transaction information memory 55e to “1” (committed) (Step S91), and responds to the active server with the completion of committing (Step S92).

As described above, two apparatuses, i.e., the active server and the client #1 transmit the commit request message (instruction to commit) to the stand-by server. Whether the instruction to commit is directly transmitted from the client #1 or whether the instruction to commit is transmitted from the active server is determined by the client #1 (distinguished using the mirroring commit flag of the commit request message). If the instruction to commit is directly transmitted from the client #1, all of the request messages and all of the response messages for the transaction processing to the stand-by server is allowed to be checked. Accordingly, the stand-by server performs the commit processing based on the information in the transaction information memory 55e which the stand-by server has.

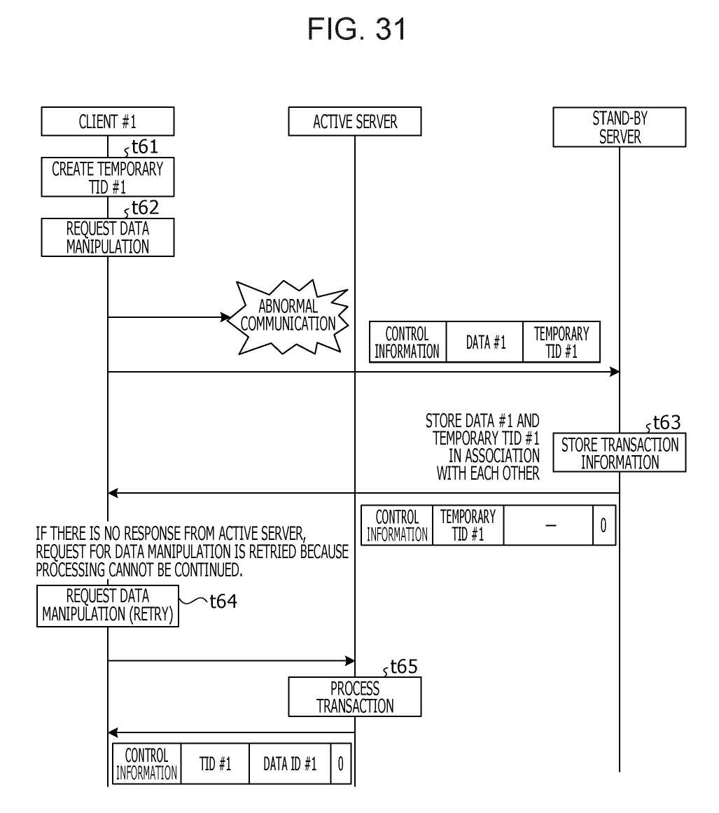

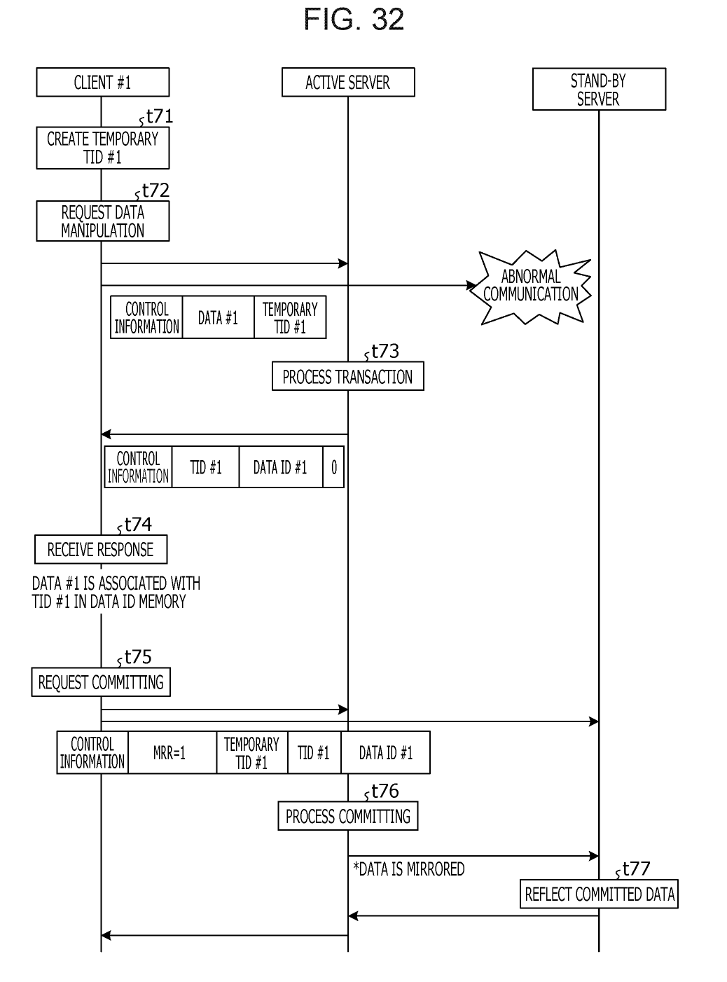

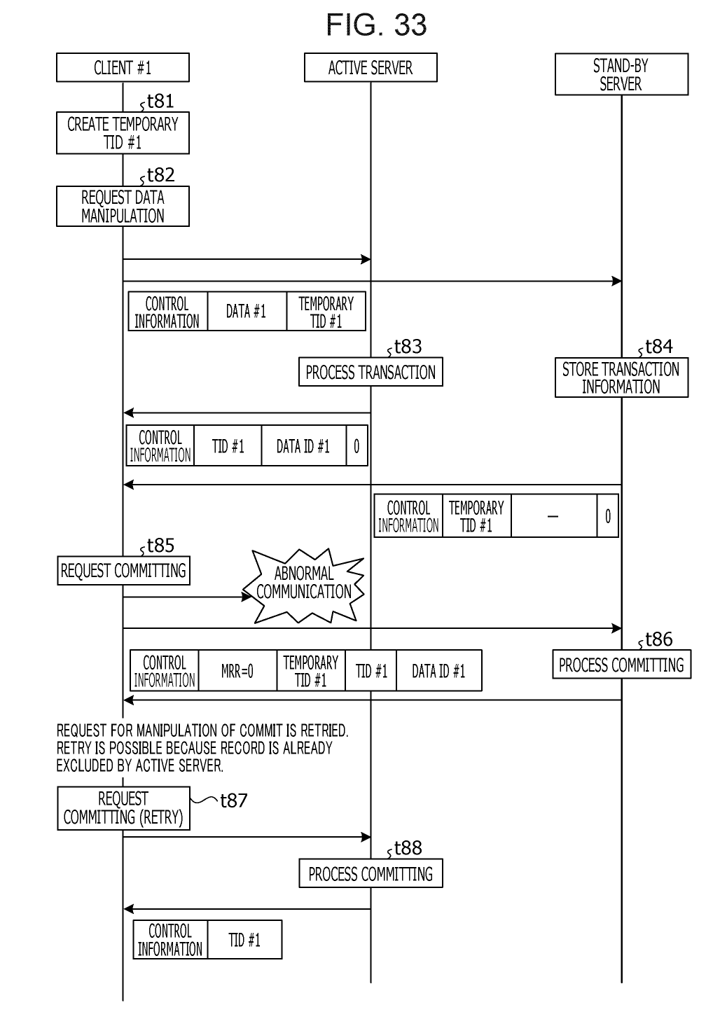

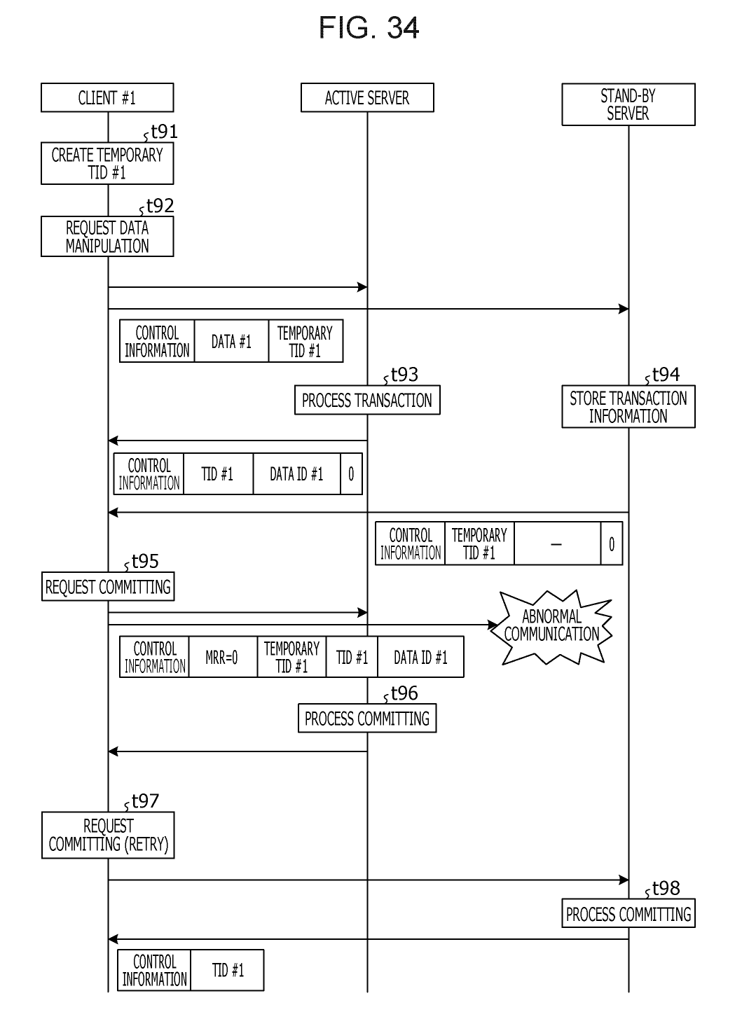

A flow of the processing when communication abnormal (such as lost packet) occurs between the client #1 and the active server or stand-by server will now be described with reference to FIGS. 31 to 34. FIG. 31 illustrates the case where abnormality occurs in the communication path between the client #1 and the active server during the requesting of the data manipulation, and FIG. 32 illustrates the case where abnormality occurs in the communication path between the client #1 and the stand-by server during the requesting of the data manipulation. FIG. 33 illustrates the case where abnormality occurs in the communication path between the client #1 and the active server during the commit requesting, and FIG. 34 illustrates the case where abnormality occurs in the communication path between the client #1 and the stand-by server during the commit requesting.

FIG. 31 is a diagram illustrating a flow when there is not response from the active server to the data manipulation request. As illustrated in FIG. 31, the client #1 creates the temporary TID #1 (t61), and transmits the data manipulation request to the active server and the stand-by server (t62). A communication abnormality occurs between the client #1 and the active server.

The stand-by server having received the data manipulation request stores the transaction information (t63), and responds to the client #1. Herein, the transaction information represents the data #1 and the temporary TID #1. Since there is no response from the active server because of the abnormal communication between the client #1 and the active server, the client #1 transmits the data manipulation request to the active server (t64).

The active server having received the data manipulation request then performs the transaction processing (t65), and transmits the response message containing the TID #1 and the data ID #1 to the client #1. If communication abnormality occurs between the client #1 and the active server during the requesting of the data manipulation, the client #1 may treat with temporary abnormal communication as above.

FIG. 32 is a diagram illustrating a flow when there is no response from the stand-by server to the data manipulation request. As illustrated in FIG. 32, the client #1 creates the temporary TID #1 (t71), and transmits the data manipulation request to the active server and the stand-by server (t72). A communication abnormality occurs between the client #1 and the stand-by server.

The active server having received the data manipulation request performs the transaction processing (t73), and transmits the response message containing the TID #1 and the data ID #1 to the client #1. The client #1 receives the response from the active server (t74), and associates the data #1 with the TID #1 in the data ID memory 66.

The client #1 then transmits the commit request to the active server and the stand-by server (t75). At this time, the client #1 sets the MRR to “1”. The active server performs the commit processing (t76), and then mirroring of the data. The stand-by server having received a mirroring instruction reflects the committed data transmitted from the active server (t77).

As above, if a communication abnormality occurs between the client #1 and the stand-by server during the requesting of the data manipulation, an MRR set at “1” enables the client #1 to instruct the active server to perform mirroring.

FIG. 33 is a diagram illustrating a flow when there is no response from the active server to the commit request. As illustrated in FIG. 33, the client #1 creates the temporary TID #1 (t81), and transmits the data manipulation request to the active server and the stand-by server (t82).

The active server having received the data manipulation request performs the transaction processing (t83), and transmits the response message containing the TID #1 and the data ID #1 to the client #1. The stand-by server having received the data manipulation request checks the transaction information (t84), and transmits the response message containing the temporary TID #1 to the client #1.

The client #1 receives the responses from the active server and the stand-by server, and transmits the commit request to the active server and the stand-by server (t85). At this time, the client #1 sets the MRR to the “0”. A communication abnormality then occurs between the client #1 and the active server, and the active server is not allowed to receive the commit request. On the other hand, the stand-by server performs the commit processing (t86), and returns the response to the client #1.

The client #1 retransmits the commit request to the active server (t87). The active server then performs the commit processing (t88), and returns the response to the client #1.

As above, if a communication abnormality occurs between the client #1 and the active server during the commit requesting, the client #1 is allowed to retry to treat with temporary abnormal communication.

FIG. 34 is a diagram illustrating a flow when there is no response from the stand-by server to the commit request. As illustrated in FIG. 34, the client #1 creates the temporary TID #1 (t91), and transmits the data manipulation request to the active server and the stand-by server (t92).

The active server having received the data manipulation request performs the transaction processing (t93), and transmits the response message containing the TID #1 and the data ID #1 to the client #1. The stand-by server having received the data manipulation request stores the transaction information (t94), and transmits the response message containing the temporary TID #1 to the client #1.

The client #1 receives the responses from the active server and the stand-by server, and transmits the commit request to the active server and the stand-by server (t95). At this time, the client #1 sets the MRR to “0”. A communication abnormality then occurs between the client #1 and the stand-by server, and the stand-by server is not allowed to receive the commit request. On the other hand, the active server performs the commit processing (t96), and returns the response to the client #1.

The client #1 retransmits the commit request to the stand-by server (t97). The stand-by server then performs the commit processing (t98), and returns the response to the client #1.

As above, if a communication abnormality occurs between the client #1 and the stand-by server during the commit requesting, the client #1 is allowed to retry to treat with temporary abnormal communication.

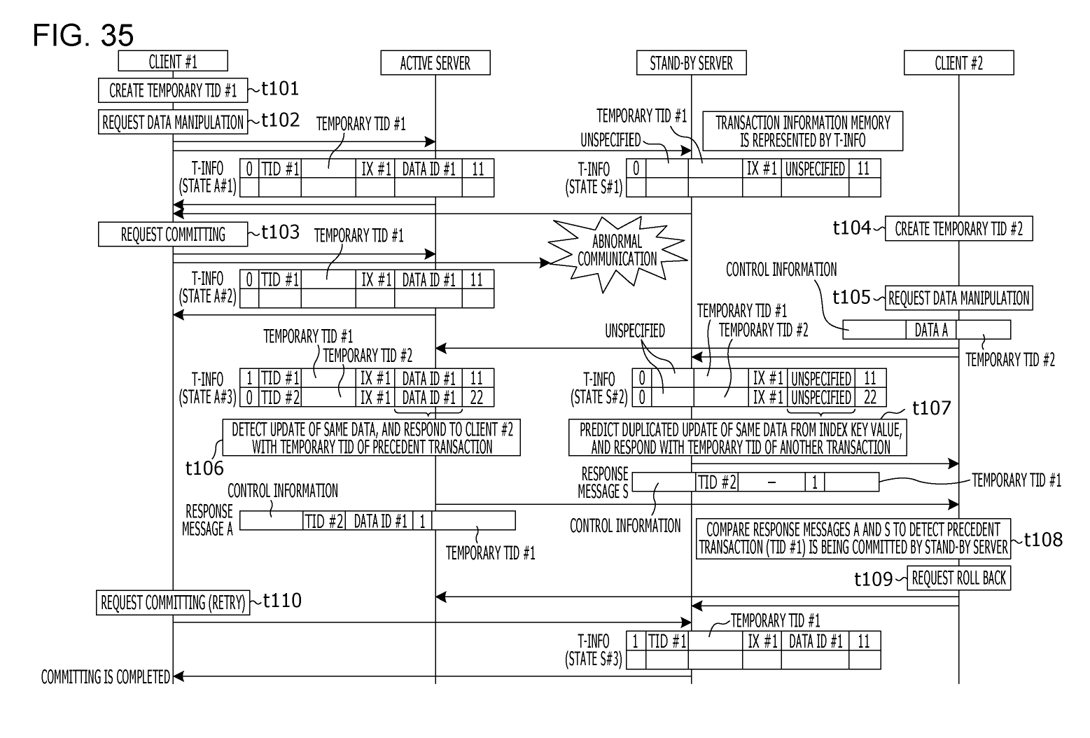

A flow of the processing when in FIG. 34 the client #2 manipulates the same data as that manipulated by the client #1 at the timing in which the client #1 is retrying the commit request to the stand-by server will now be described with reference to FIGS. 35 to 38. Whether the client #1 and the client #2 manipulate the same data may be determined only using the data ID assigned by the active server. The client #2 may compare the temporary transaction ID returned from the active server to that returned from the stand-by server to detect that the client #1 is committing the data (retrying the commit request).

FIG. 35 is a diagram illustrating a flow when the stand-by server does not respond to the commit operation request, and the same data as the data to be processed is manipulated by another application while the stand-by server is retrying. As illustrated in FIG. 35, the client #1 creates the temporary TID #1 (t101), and transmits the data manipulation request to the active server and the stand-by server (t102).

In the data manipulation request, the client #1 updates the data having an index key value “IX #1” to “11”. When receiving the data manipulation request, the active server locks the data having a data ID #1 with the TID #1. The T-INFO in the active server represents the transaction information memory 55a, and the T-INFO in the stand-by server represents the transaction information memory 55e.

When receiving the responses from the active server and the stand-by server, the client #1 transmits the commit request to the active server and the stand-by server (t103). A communication abnormality then occurs between the client #1 and the stand-by server, and the stand-by server is not allowed to receive the commit request. On the other hand, the active server performs the commit processing, and returns the response to the client #1. At this time, the active server unlocks the data ID #1, which has been locked with the TID #1.

On the other hand, the client #2 creates the temporary TID #2 (t104), and transmits the data manipulation request to the active server and the stand-by server (t105). In the data manipulation request, the client #2 updates the data having an index key value “IX #1” to “22”.

When receiving the data manipulation request from the client #2, the active server detects the update of the same data as the data to be processed based on the information in the transaction information memory 55a, and returns the temporary TID of the precedent transaction to the client #2 with a response message A (t106). Although the active server is performing the transaction TID #1 at this time, the data having the data ID #1 is locked with TID #2.

On the other hand, when receiving the data manipulation request from the client #2, the stand-by server predicts duplicated update of identical data from the index key value based on the information in the transaction information memory 55e, and returns the temporary TID of another transaction to the client #2 with a response message S (t107).

The client #2 compares the response message A to the response message S, detects that the precedent transaction (TID #1) is being committed by the stand-by server (t108), and transmits the roll back request to the active server and the stand-by server (t109).

Subsequently, the client #1 retransmits the commit request to the stand-by server (t110). The stand-by server receives the commit request, and performs the commit processing. The committing is then completed.

As above, the client #2 may compare the response message A to the response message S to detect that the precedent transaction is being committed and to perform roll back.

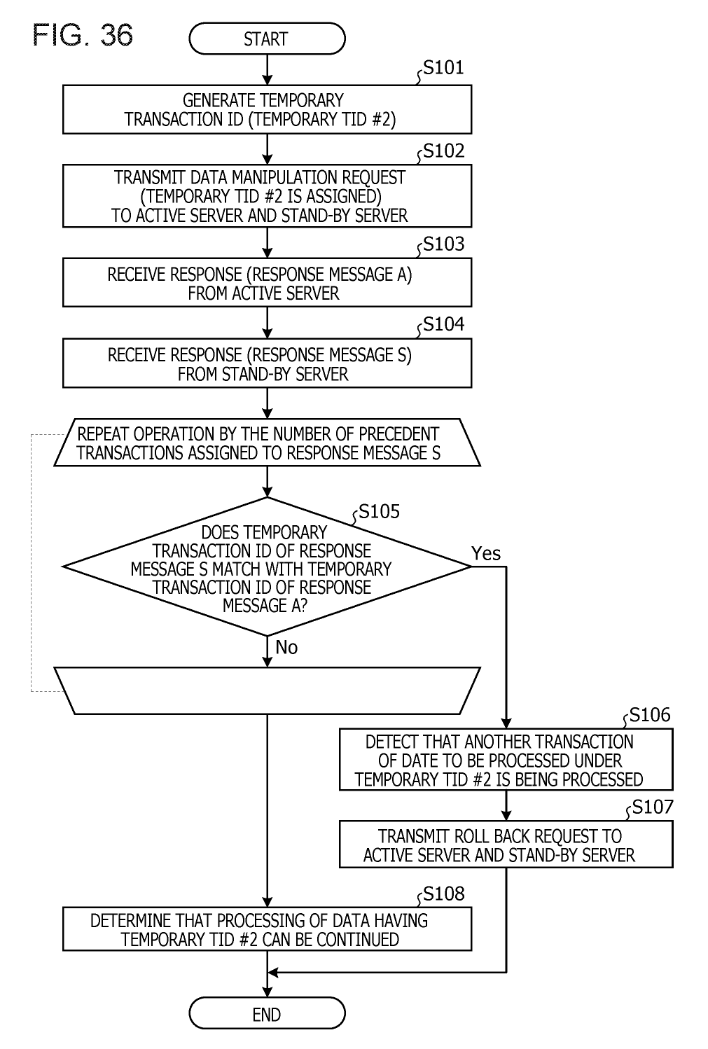

FIG. 36 is a flowchart illustrating a flow of the processing for the client #2 to check the precedent transaction. As illustrated in FIG. 36, the client #2 generates the temporary transaction ID (temporary TID #2) (Step S101), and transmits the data manipulation request to the active server and the stand-by server (Step S102). The data manipulation request has the temporary TID #2.

The client #2 then receives the response (response message A) from the active server (Step S103), and receives the response (response message S) from the stand-by server (Step S104). The client #2 then determines whether the temporary transaction ID in the response message S matches with that in the response message A or not (Step S105). The client #2 repeats this determination by the number of precedent transactions assigned to the response message S.

If the temporary transaction ID in the response message S matches with that in the response message A, the client #2 detects that another transaction is being committed to the data to be processed under the temporary TID #2 (Step S106). The client #2 then transmits the roll back request to the active server and the stand-by server (Step S107).

If the temporary transaction ID in the response message S does not match with that in the response message A, the client #2 determines that the processing may be continuously performed on the data having the temporary TID #2 (Step S108).

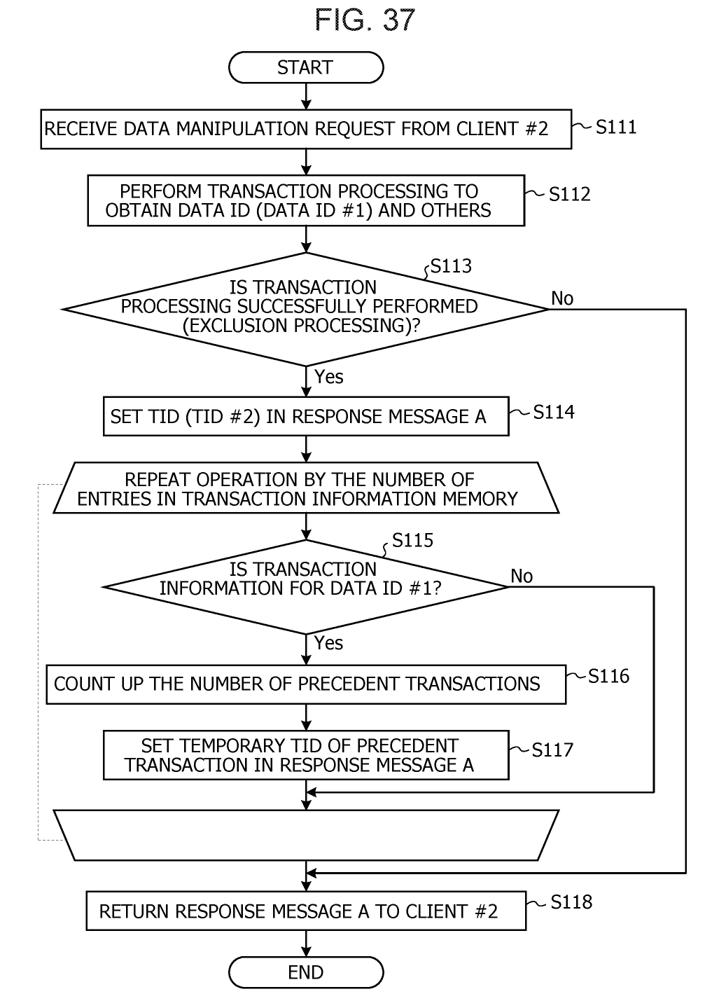

FIG. 37 is a flowchart illustrating a flow of the processing in which the active server receives the data manipulation request from the client #2, and checks the precedent transaction. As illustrated in FIG. 37, the active server receives the data manipulation request from the client #2 (Step S111). The active server then performs the transaction processing, and obtains the data ID (data ID #1) (Step S112).

The active server determines whether the transaction processing is successfully performed or not (Step S113). If the transaction processing is not successfully performed, the processing goes to Step S118. If the transaction processing is successfully performed, the active server sets the TID (TID #2) in the response message A (Step S114), and repeats the processing from Steps S115 to S117 by the number of entries in the transaction information memory 55a.

The active server determines whether each of the entries is the transaction information on the data ID #1 or not (Step S115). If the entry is not the transaction information on the data ID #1, the active server goes to the subsequent entry. If the entry is the transaction information on the data ID #1, the active server counts up the number of precedent transactions (Step S116), and sets the temporary TID of the precedent transaction in the response message A (Step S117). Herein, the number of precedent transactions is the number of PREV-TIDs illustrated in FIG. 18.

The active server then returns the response message A to the client #2 (Step S118).

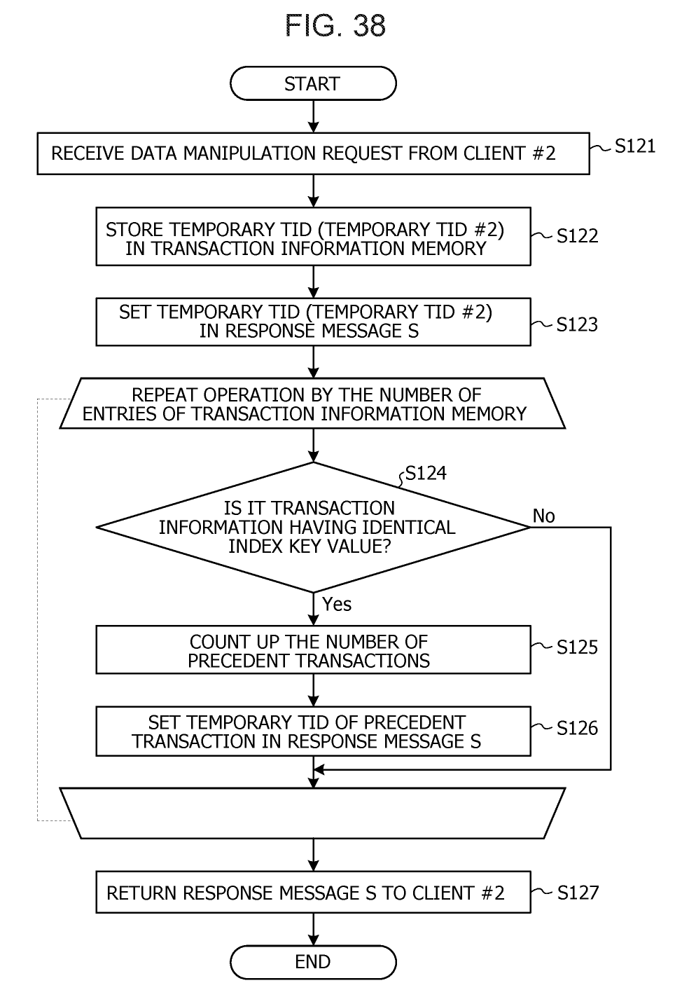

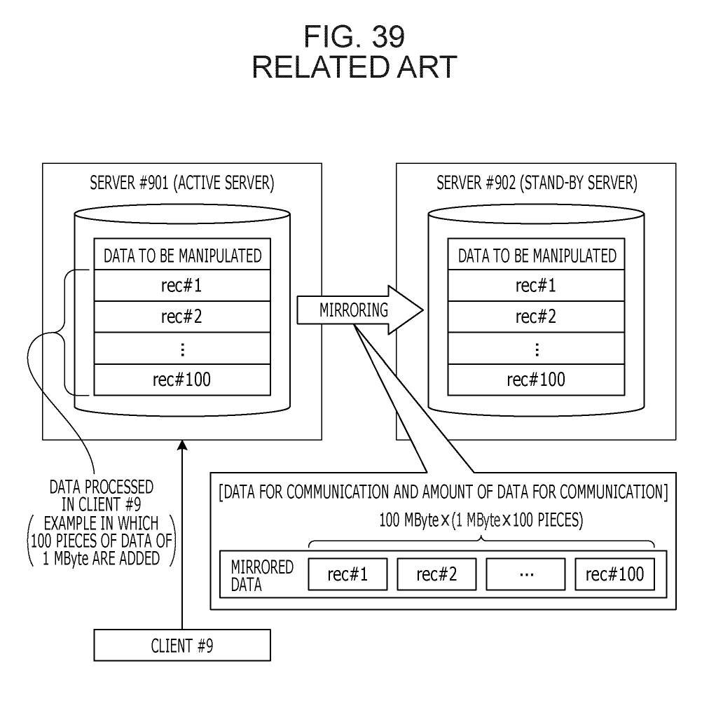

FIG. 38 is a flowchart illustrating a flow of the processing in which the stand-by server receives the data manipulation request from the client #2, and checks the precedent transaction. As illustrated in FIG. 38, the stand-by server receives the processing request from the client #2 (Step S121). The stand-by server then stores the temporary TID (temporary TID #2) in the transaction information memory 55e (Step S122).

The stand-by server then sets the temporary TID (temporary TID #2) in the response message S (Step S123), and repeats the processing from Steps S124 to S126 by the number of entries in the transaction information memory 55e.

The stand-by server determines whether each of the entries is the transaction information having the same index key as that of the data contained in the data manipulation request (Step S124). If the entry is not the transaction information having the same index key, the stand-by server goes to the subsequent entry. If the entry is the transaction information having the same index key, the stand-by server counts up the number of precedent transactions (Step S125), and sets the temporary TID of the precedent transaction in the response message S (Step S126).

The stand-by server then returns the response message S to the client #2 (Step S127).

As has described above, in the embodiment, the temporary transaction ID generator 67 in the client #1 generates the temporary transaction ID. The request transmitter 68 adds the temporary transaction ID to the first request message, and transmits the first request message to the active server and the stand-by server. When the active server receives the first request message, the transaction ID generator 55c in the active server generates the transaction ID, and the data ID generator 55d generates the data ID. The transaction processor 55b returns the response message having the transaction ID and the data ID to the client #1. The request transmitter 68 adds the transaction ID and the data ID to the second request message, and transmits the second request message to the active server and the stand-by server. The data manager 55f in the stand-by server having received the first request message and the second request message manages the transaction information associating the temporary transaction ID with the transaction ID and the data ID. When the commit request is received from the client #1, the data manager 55f performs the commit processing based on the transaction information.

Accordingly, the information processing system 1 may keep the consistency between the active server and the stand-by server without mirroring, and reduce a decrease in the transaction performance caused by mirroring.

In the embodiment, the data ID memory 66 in the client #1 stores the temporary transaction ID, the transaction ID, and the data ID in association with each other. The request transmitter 68 creates the second request message using the data ID memory 66, and transmits the second request message. The transaction information memory 55a in the active server stores the temporary transaction ID, the transaction ID, and the data ID in association with each other. When the commit request is received from the client #1, the transaction processor 55b performs the commit processing using the transaction information memory 55a. The transaction information memory 55e in the stand-by server stores the temporary transaction ID, the transaction ID, and the data ID in association with each other. When the commit request is received from the client #1, the data manager 55f performs the commit processing using the transaction information memory 55e.

Accordingly, the client #1, the active server, and the stand-by server may associate the temporary transaction ID, the transaction ID, and the data ID with each other.

In the embodiment, if the request transmitter 68 performs the commit request without receiving the response to the data manipulation request from the stand-by server, the request transmitter 68 sets the mirroring commit flag to “ON”, and instructs the active server and the stand-by server to commit the data. If the mirroring commit flag is “ON”, the transaction processor 55b transmits the information for mirroring to the stand-by server. The data manager 55f receives the information for mirroring from the active server, and performs the commit processing.

Accordingly, even if a communication abnormality occurs between the client #1 and the stand-by server, the information processing system 1 may keep the consistency between the active server and the stand-by server.

In the embodiment, if the transaction processor 55b performs the commit processing of the transaction from the client #1, and then receives the data manipulation request from the client #1, the transaction processor 55b deletes the information on the transaction subjected to the commit processing in the transaction information memory 55a. If the transaction processor 55b receives the request to manipulate the data having the same data ID from the client #2 after the commit processing of the transaction from the client #1, the transaction processor 55b adds the temporary TID of the transaction having the same data ID as that of the transaction from the client #1 to the response, and transmits the response to the client #2. If the data manager 55f performs the commit processing on the transaction from the client #1, and then receives the data manipulation request from the client #1, the data manager 55f deletes the information on the transaction subjected to the commit processing in the transaction information memory 55e. In the data manager 55f receives the request to manipulate the data presumed to have the same data ID from the client #2 before the commit processing of the transaction from the client #1, the data manager 55f adds the temporary TID of the transaction presumed to have the data ID to the response, and transmits the response to the client #2. If the temporary TID contained in the response from the active server is identical to the temporary TID contained in the response from the stand-by server, the client #2 requests the active server and the stand-by server to roll back.

Accordingly, even if a communication abnormality occurs between the client #1 and the stand-by server, the information processing system 1 may keep the consistency between the active server and the stand-by server.

The execution of the same processing by the active server and the stand-by server doubles resources. In the present embodiment, the stand-by server only manages the data based on the information assigned by the active server as the results of control of the order of transactions and specification of the data (transaction ID, data ID). Accordingly, use of the resources by the stand-by server is reduced compared to the active server. In the present embodiment, the consistency of the transaction and the order of processing between the client and the server is guaranteed based on the information assigned by the active server as the results of control of the order of transactions and specification of the data (transaction ID, data ID). For this reason, the consistency of the transaction and the order of processing are guaranteed without any distribution apparatus.

If the transaction processing is performed by each of servers (for example, the case where the transaction processing is performed by the active server and the stand-by server), the order of processing the transactions is not allowed to have consistency among all of the server apparatuses 2 including a redundant configuration. In the present embodiment, only the active server assigns information on the transaction (transaction ID, data ID) and determines the order of processing, and hands the information to the client apparatus 3 and the request message through the response message. Accordingly, the uniqueness of the transaction is guaranteed among all of the server apparatuses 2 including the redundant configuration.

Moreover, if the client apparatus 3 waits for the responses from both the active server and the stand-by server, the response during the processing is reduced. In the present embodiment, the response from the active server is waited in a synchronizing manner, and the response from the stand-by server is waited in a non-synchronizing manner. In such a configuration, the responses from the active server and the stand-by server is allowed to be checked while the response of the processing of a job performed in the active server is kept.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory, computer-readable recording medium having stored therein a program for causing a first processor to execute a process, the first processor being included in an information processing system that includes a second processor configured to store data used by an application and receive a transaction of the data and a third processor configured to operate as a stand-by apparatus while the second processor operates as an active apparatus, the process comprising:
generating a temporary transaction identifier for identifying the transaction;
adding the generated temporary transaction identifier to a first request about the transaction, and transmitting the first request to the second processor and the third processor; and
upon receipt of a response to the first request from the second processor, extracting a transaction identifier for identifying the transaction and a data identifier for identifying the data from the response, adding the transaction identifier and the data identifier to a second request about the transaction, and transmitting the second request to the second processor and the third processor.

2. An information processing system comprising:
a first processor configured to operate an application;
a second processor configured to receive a transaction with respect to the data from the first processor; and
a third processor configured to operate as a stand-by processor while the second processor operates as an active processor,
wherein the first processor generates a temporary transaction identifier for identifying the transaction, adds the generated temporary transaction identifier to a first request about the transaction, and transmits the first request to the second processor and the third processor,
when the second processor receives the first request, the second processor determines a transaction identifier for identifying the transaction, determines a data identifier for identifying data to be processed by the first request, adds the transaction identifier and the data identifier to a response to the first request, and transmits the response to the first processor,
when the first processor receives the response, the first processor adds the transaction identifier and the data identifier contained in the response to a second request about the transaction, and transmits the second request to the second processor and the third processor, and
the third processor manages transaction information for associating the temporary transaction identifier contained in the first request with the transaction identifier and the data identifier contained in the second request, and upon receipt of a commit request about the transaction from the first processor, the third processor performs commit processing on the transaction based on the transaction information.

3. The information processing system according to claim 2,
wherein the first processor further comprises a first transaction information memory configured to store the temporary transaction identifier, the transaction identifier, and the data identifier in association with each other,
the first processor creates the second request for using the first transaction information memory, and transmits the second request,
the second processor further comprises a second transaction information memory configured to store the temporary transaction identifier, the transaction identifier, and the data identifier in association with each other,
upon receipt of the commit request about the transaction from the first processor, the second processor performs the commit processing for using the second transaction information memory,
the third processor further comprises a third transaction information memory configured to store the temporary transaction identifier, the transaction identifier, and the data identifier in association with each other, and
the third processor performs the commit processing for using the third transaction information memory.

4. The information processing system according to claim 2,
wherein when the first processor receives a response to the second request from the second processor, does not receive a response to the second request from the third processor, and performs the commit request, the first processor instructs the second processor and the third processor to perform mirroring,
the second processor performs the commit processing, and then transmits mirroring information for performing mirroring to the third processor, and
the third processor receives the mirroring information, and performs the commit processing.

5. The information processing system according to claim 3,
wherein when the second processor receives a request for a new transaction from the first processor after the commit processing, the second processor deletes information stored by the second transaction information memory about the transaction subjected to the commit processing, and when after the commit processing, the second processor receives, from a fourth processor different from the first processor, a request for a new transaction having the same data identifier as that of the transaction from the first processor, the second processor adds, to a response, the temporary transaction identifier stored by the second transaction information memory about the transaction having the same data identifier as that of the transaction from the first processor, and transmits the response to the fourth processor,
when the third processor receives a request for a new transaction from the first processor after the commit processing, the third processor deletes information stored by the third transaction information memory about the transaction subjected to the commit processing, and when before the commit processing, the third processor receives from the fourth processor a request for a new transaction presumed to have the same data identifier as that of the transaction from the first processor, the third processor adds, to a response, the temporary transaction identifier stored by the third transaction information memory about the transaction having the same data identifier, and transmits the response to the fourth processor, and
when the temporary transaction identifier contained in the response transmitted from the second processor is identical to the temporary transaction identifier contained in the response transmitted from the third processor, the fourth processor requests the second processor and the third processor to roll back.

6. An information processing apparatus included in an information processing system including a second processor configured to store data used by an application, and accept a transaction of the data; and a third processor configured to operate as a stand-by apparatus while the second processor operates as an active apparatus, the information processing apparatus comprising:
a first processor configured to generate a temporary transaction identifier as a temporary identifier for identifying the transaction, wherein
the first processor adds the generated temporary transaction identifier to a first request for the transaction, and transmits the first request to the second processor and the third processor; and upon receipt of a response to the first request from the second processor, the first processor extracts a transaction identifier for identifying the transaction and a data identifier for identifying the data from the response, adds the transaction identifier and the data identifier to a second request about the transaction, and transmits the second request to the second processor and the third processor.

7. An information processing method by an information processing system that has a first processor in which an application operates, a second processor configured to store data used by the application, and receive a transaction of the data from the first processor, and a third processor configured to operate as a stand-by apparatus while the second processor operates as an active apparatus, the method comprising:
by the first processor,
generating a temporary transaction identifier for identifying the transaction,
adding the generated temporary transaction identifier to a first request for the transaction, and
transmitting the first request to the second processor and the third processor,
when the second processor receives the first request,
by the second processor,
determining a transaction identifier for identifying the transaction,
determining a data identifier for identifying data to be processed by the first request,
adding the transaction identifier and the data identifier to a response to the first request, and transmits the response to the first processor,
when the first processor receives the response,
by the first processor,
adding the transaction identifier and the data identifier contained in the response to a second request for the transaction, and
transmitting the second request to the second processor and the third processor, and
by the third processor,
managing transaction information for associating the temporary transaction identifier contained in the first request with the transaction identifier and the data identifier contained in the second request, and
upon receipt of a commit request about the transaction from the first processor, performing commit processing on the transaction based on the transaction information.
